(19) United States
(12) Patent Application Publication
(10) Pub. No.: US 2006/0135647 A1
(43) Pub. Date: Jun. 22, 2006

(54) Aqueous ink, ink tank, ink jet recording apparatus, ink jet recording method, and ink jet recorded image

(75) Inventors: Yoko Ichinose, Tokyo (JP); Masashi Miyagawa, Yokohama-shi (JP); Junichi Sakai, Tokyo (JP); Yoshio Nakajima, Yokohama-shi (JP); Hirofumi Ichinose, Tokyo (JP); Mikio Sanada, Yokohama-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/311,619

(22) Filed: Dec. 20, 2005

Related U.S. Application Data
(63) Continuation of application No. PCT/JP05/12149, filed on Jun. 24, 2005.

(30) Foreign Application Priority Data
Jun. 24, 2004 (JP) 2004-186930

(51) Int. Cl. C03C 17/00

(52) U.S. Cl. 523/160

(57) ABSTRACT

Provided are an aqueous ink containing: water; multiple water-soluble organic solvents; and a dispersible colorant, the aqueous ink containing a good medium with respect to the dispersible colorant and a bad medium with respect to the dispersible colorant as the water-soluble organic solvents, in which: the dispersible colorant is a dispersible colorant having a colorant and chargeable resin pseudo fine particles each of which is smaller than the colorant in which the colorant and the chargeable resin pseudo fine particles fix to each other; and when a total amount of the good medium in the ink (mass %) is denoted by A and a total amount of the bad medium in the ink (mass %) is denoted by B, A:B is in the range of 10:5 to 10:30.

This application is a continuation of International Application No. PCT/JP2005/012149, filed Jun. 24, 2005, which claims the benefit of Japanese Patent Application No. 2004-186930 filed on Jun. 24, 2004.

### BACKGROUND OF THE INVENTION

1. Field of the Invention

The present invention relates to an aqueous ink containing a dispersible colorant, an ink tank, an ink jet recording apparatus, an ink jet recording method, and an ink jet recorded image.

2. Related Background Art

A water-insoluble colorant serving as a coloring agent, such as ink containing a pigment (pigment ink), has been conventionally known to provide an image excellent in fastness properties such as water resistance and light resistance. Such colorant must be stably dispersed into water before it is used for aqueous ink for ink jet recording. In this case, a method involving the use of a surfactant or a polymer dispersant (which may hereinafter be referred to as a dispersion resin) to stabilize the dispersion has been generally used.

An approach to chemically modifying the surface of a water-insoluble colorant has also been proposed (see, for example, Japanese Patent Application Laid-Open No. H10-195360). A microcapsule-type pigment obtained by coating a pigment with a resin has also been proposed (see, for example, Japanese Patent Application Laid-Open No. H08-183920 and Japanese Patent Application Laid-Open No. 2003-34770). In particular, Japanese Patent Application Laid-Open No. 2003-34770 discloses an aqueous colored fine particle dispersion containing a water-insoluble coloring agent, and discloses that “an aqueous colored fine particle dispersion, characterized in that: the colored fine particle dispersion is prepared by dispersing a water-insoluble coloring agent into an aqueous medium in the presence of a dispersant and adding a vinyl monomer to the dispersion to polymerize the monomer; the dispersant shows dispersion stability when the water-insoluble coloring agent is dispersed; and the stability of a latex to be produced is bad when the vinyl monomer is polymerized in the presence of only the dispersant.”

Meanwhile, various techniques have been proposed with a view to additionally increasing the optical density of an image formed by means of such ink. For example, it has been proposed that an image density can be additionally increased by using ink containing self-dispersible carbon black and a specific salt (see, for example, Japanese Patent Application Laid-Open No. 2000-198955). A technique has also been proposed, which involves: allowing ink for ink jet recording, which is a composition containing a pigment, a polymer fine particle, a water-soluble organic solvent, and water, and a polyvalent metal-containing aqueous solution to fix to a recording medium; and allowing the ink composition and the polyvalent metal-containing aqueous solution to react with each other to form a high-quality image (see, for example, Japanese Patent Application Laid-Open No. 2000-63719). In each of those techniques, a pigment dispersed into ink is forcedly agglomerated on the surface of a recording medium to suppress the penetration of the pigment into the recording medium, whereby an image having a density higher than that of an image obtained by means of the conventional pigment ink is obtained.

### SUMMARY OF THE INVENTION

At present, various kinds of recording media have been present, but no ink capable of providing a high printing density at all times irrespective of the penetration performance of a recording medium and of providing a printed matter with sufficient abrasion resistance, marker resistance, and water resistance has been obtained.

Therefore, an object of the present invention is to provide an aqueous pigment ink capable of providing a high printing density at all times irrespective of the penetration performance of a recording medium and of providing a printed matter with excellent abrasion resistance, marker resistance, and water resistance. Another object of the present invention is to provide an aqueous ink capable of providing a high printing density at all times while having excellent long-term storage stability and eject stability. Another object of the present invention is to provide an aqueous ink which has excellent printing quality and has bleed resistance with which the occurrence of bleeding with any other ink is suppressed. Another object of the present invention is to provide an aqueous ink which maintains a high printing density at all times and has excellent quick drying property. Another object of the present invention is to provide an ink tank, an ink jet recording apparatus, an ink jet recording method, and an ink jet recorded image each using such aqueous ink.

With a view to achieving the above objects, the inventors of the present invention have made extensive studies. As a result, they have obtained an aqueous ink containing: water; multiple water-soluble organic solvents; and a dispersible colorant having a novel structure, the aqueous ink containing a good medium with respect to the dispersible colorant and a bad medium with respect to the dispersible colorant as the water-soluble organic solvents each at a specific ratio, the aqueous ink having excellent long-term storage stability and eject stability, the aqueous ink being capable of providing a high printing density irrespective of the penetration performance of a recording medium and of providing a printed matter with excellent abrasion resistance, marker resistance, and water resistance.

That is, according to one aspect of the present invention, there is provided an aqueous ink containing: water; multiple water-soluble organic solvents; and a dispersible colorant, the aqueous ink containing a good medium with respect to the dispersible colorant and a bad medium with respect to the dispersible colorant as the water-soluble organic solvents each at a specific ratio, in which:

the dispersible colorant is a dispersible colorant having a colorant and chargeable resin pseudo fine particles each of which is smaller than the colorant in which the colorant and the chargeable resin pseudo fine particles fix to each other; and

when a total amount of the good medium in the ink (mass %) is denoted by A and a total amount of the bad medium in the ink (mass %) is denoted by B, A:B is in the range of 10:5 to 10:30, and a water-soluble organic solvent showing the maximum Ka value out of respective Ka values of the multiple water-soluble organic solvents each determined by a Bristow method is the bad medium.

According to another aspect of the present invention, there is provided an ink tank including the aqueous ink.

According to another aspect of the present invention, there is provided an ink jet recording apparatus for forming an ink jet recorded image by means of the aqueous ink.

According to another aspect of the present invention, there is provided an ink jet recording method including forming an image in an ink jet recording apparatus by means of the aqueous ink.

According to another aspect of the present invention, there is provided an ink jet recorded image formed by an ink jet recording apparatus by means of the aqueous ink.

According to the present invention, there is provided an aqueous ink which has excellent long-term storage stability and eject stability, and is capable of providing a high printing density irrespective of the penetration performance of a recording medium and of providing a printed matter with excellent abrasion resistance, marker resistance, and water resistance. As another effect of the present invention, there is provided an aqueous ink capable of providing a high printing density at all times while having excellent long-term storage stability and eject stability. As another effect of the present invention, there is provided an aqueous ink which has excellent printing quality and has bleed resistance against any other ink. As another effect of the present invention, there is provided an aqueous ink which maintains a high printing density at all times and has excellent quick drying property.

As another effect of the present invention, there is provided an ink jet recording method involving the use of such aqueous ink to provide good printing performance even in a plain paper medium having high penetrability. As another effect of the present invention, there are provided an ink tank, an ink jet recording apparatus, and an ink jet recorded image each of which can be suitably used for the ink jet recording method.

### BRIEF DESCRIPTION OF THE DRAWINGS

FIGS. 1A and 1B are schematic views each showing the basic structure of a dispersible colorant with which flat chargeable resin pseudo fine particles are fused according to the present invention;

FIGS. 2A, 2B, 2C, and 2D are schematic views each showing a representative step in a production method of the present invention;

FIG. 3 is a schematic view showing processes of flat chargeable resin pseudo fine particles in the production method of the present invention and fusion of the particles with a colorant;

FIG. 4 is a schematic view showing chargeable resin pseudo fine particles of the present invention enlarged from the side of an interface at which they are fused with a colorant;

FIG. 5 is an enlarged schematic view showing an interface at which the chargeable resin pseudo fine particles of the present invention are fused with a colorant;

FIGS. 6A and 6B are schematic view each showing a pigment peeling phenomenon upon direct modification of an organic pigment with a hydrophilic group typified by Japanese Patent Application Laid-Open No. H10-195360;

FIGS. 7A, 7B, 7C, and 7D are explanatory views for schematically explaining how a droplet of an ink according to the present invention impinges on the surface of a recording medium;

FIG. 8 is a view showing an example of a recording head used in the present invention;

FIG. 9 is a view showing an example of a recording head used in the present invention;

FIG. 10 is a view showing an example of a recording head used in the present invention;

FIG. 11 is a view showing an example of a recording head used in the present invention;

FIG. 12 is a view showing an example of a recording head used in the present invention; and

FIG. 13 is a view showing an example of a recording head used in the present invention.

### DESCRIPTION OF THE PREFERRED EMBODIMENTS

Hereinafter, the present invention will be described in more detail by way of preferred embodiments. The aqueous ink according to the present invention, which can be used for a recording method based on a writing instrument such as a pen, an ink jet recording method, and other various printing methods, is particularly suitably used for the ink jet recording method.

[Dispersible Colorant]

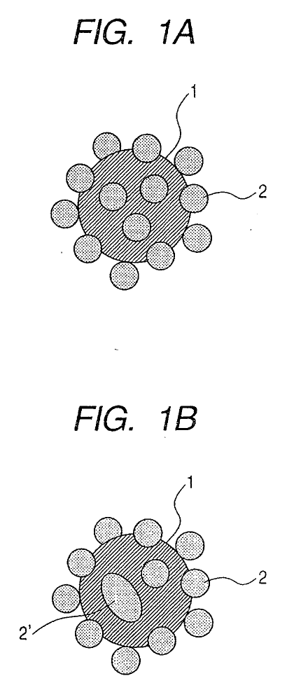

A first feature of a dispersible colorant to be used in the present invention lies in that the dispersible colorant is composed of a colorant and chargeable resin pseudo fine particles, and the chargeable resin pseudo fine particles fix to the colorant. FIGS. 1A and 1B are schematic views each showing a dispersible colorant in which chargeable resin pseudo fine particles 2 fix to a colorant 1, the dispersible colorant characterizing the present invention. A portion denoted by 2′ in FIG. 1B is a portion schematically showing a state where part of the chargeable resin pseudo fine particles 2 adhering to the surface of the colorant 1 are fused.

The chargeable resin pseudo fine particles fix to the colorant, whereby charge is imparted by the chargeable resin pseudo fine particles to the surface of the colorant to make the dispersible colorant dispersible into water or an aqueous ink medium. At the same time, the dispersible colorant has excellent adhesiveness to a recording medium because of the presence of a resin component adhering to the surface. At this time, the resin component is not merely physically adsorbed but is in a state where the chargeable resin pseudo fine particles fix to the colorant, which is characteristic of the dispersible colorant to be used in the present invention. Therefore, the chargeable resin pseudo fine particles do not desorb from the surface of the colorant, and hence the dispersible colorant to be used in the present invention is also excellent in long-term storage stability.

The term “chargeable resin pseudo fine particles” as used herein refers to a resin aggregate in which resin components strongly agglomerate, or preferably a resin aggregate in which a large number of physical cross-linkings are formed (the term “resin aggregate” refers to a state where a resin component has a fine particle form or a stable form as a fine agglomerate close to the fine particle form). Details about the chargeable resin pseudo fine particles will be described later.

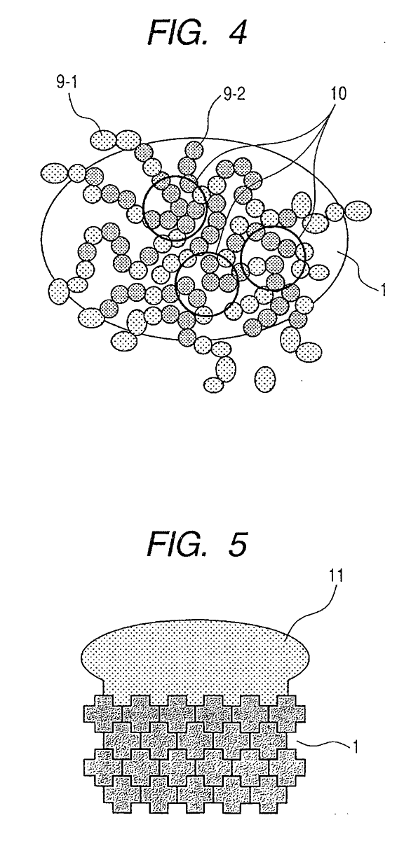

The state where the chargeable resin pseudo fine particles fix to the colorant in the present invention is due to a strong interaction between the surface of the colorant and any one of the chargeable resin pseudo fine particles, and is probably achieved in the following state. FIG. 4 is an enlarged schematic view showing an interface at which a chargeable resin pseudo fine particle fixes to the colorant. First, the chargeable resin pseudo fine particles 2 are formed by the entanglement of polymers constituted by various monomer unit compositions (denoted by 9-1 and 9-2 in the figure). Since the polymers locally have various structures at interfaces with the colorant, various states of the local surface energy are distributed. The colorant and a polymer strongly bind to each other at a point where the surface energy arising out of the chemical structure and surface structure of the colorant and the surface energy arising out of the chemical structure and surface structure of the polymer locally coincide with each other well (point indicated by a solid circle in the figure). Furthermore, as shown in FIG. 4, the interface at which one chargeable resin pseudo fine particle fixes to the colorant has multiple points denoted by 10 at each of which the surface energies of both the particle and the colorant locally coincide with each other. The adhesion state of the present specification is expected to be established by strong interactions at the multiple points. In the present invention, a state where, for example, 30% or more of the surface area of a chargeable resin pseudo fine particle fixes to a colorant as shown by 2′ in FIG. 1B is conveniently referred to as “fusion”, which is one form of adhesion, and the chargeable resin pseudo fine particle and the colorant are not necessarily fused with each other at their interface.

In particular, in the chargeable resin pseudo fine particles, the polymers constituting the particles receive strong interactions among them, and may be entangled with each other to form physical cross-linkings. As a result, even when a chargeable resin pseudo fine particle has many hydrophilic groups, neither desorption of the adhering chargeable resin pseudo fine particles from the colorant nor continuous elution of a resin component having a hydrophilic group from the chargeable resin pseudo fine particles occurs. On the other hand, in such capsulation method as described in Japanese Patent Application Laid-Open No. H08-183920 described above, a resin having high hydrophilicity cannot strongly bind to a colorant, so the resin desorbs from the colorant, with the result that sufficient long-term stability may not be obtained.

An example of a merit of the dispersible colorant to be used in the present invention having the chargeable resin pseudo fine particles adhering to the colorant includes a merit that the specific surface area of the dispersible colorant increases depending on the form of the material, and the charge which the chargeable resin pseudo fine particles have on their surfaces can be distributed to a large number of portions on the surface of the colorant. As a result, the dispersible colorant has a high specific surface area, and hence the charge which the chargeable resin pseudo fine particles have can be turned into surface charge of the dispersible colorant with extremely high efficiency. That is, the form of the dispersible colorant to be used in the present invention is a form with which an increased amount of surface charge is arranged on the surface of the dispersible colorant with improved efficiency. Therefore, as compared to the form typified by Japanese Patent Application Laid-Open No. H08-183920 in which a colorant is coated with a resin, high dispersion stability can be imparted even when the actual acid value or amine value of a resin component is lower.

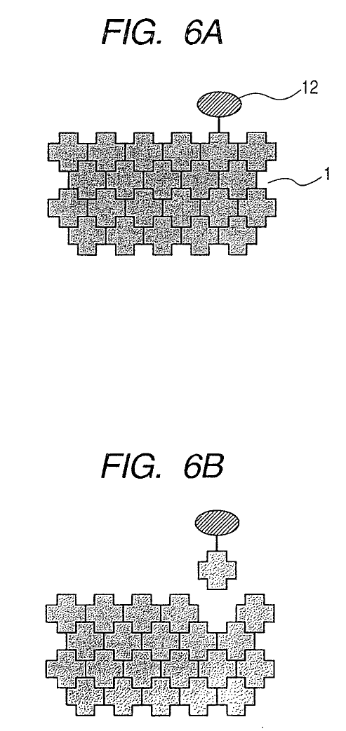

In general, an organic pigment is insolubilized (made into a pigment) by the crystallization of a color developing colorant owing to a strong interaction. In the case of a dispersible colorant using an organic pigment as the colorant to be used in the present invention, as described above, multiple interaction points are distributed at an interface between a chargeable resin pseudo fine particle and the colorant. Accordingly, a chargeable resin pseudo fine particle 11 fixes across several colorant molecules 1a in pigment particles (see FIG. 5). Therefore, “pigment peeling” caused when the colorant molecules 1a are locally made hydrophilic by a hydrophilic group 12 as explained by FIGS. 6A and 6B does not occur in the present invention. Preferably, when an organic pigment is used as the colorant, the size of each of the chargeable resin pseudo fine particles is controlled to be smaller than the dispersion particle size of the pigment and larger than the size of the colorant molecule, whereby a dispersible colorant containing the organic pigment to which high dispersibility is imparted can be obtained without the breakage of the crystal structure of the pigment.

In the present invention, a state where chargeable resin pseudo fine particles “fix” to a colorant can be easily observed by means of the following approach involving three stages of separation. First, in first separation, the colorant to be observed and other water-soluble components (including also a water-soluble resin component) in ink or a water dispersing element are separated from each other. In second separation, the colorant in the precipitate obtained as a result of the first separation and a water-insoluble resin component are separated from each other. In third separation, a resin component weakly adsorbed and the dispersible colorant to which the chargeable resin pseudo fine particles fix are separated from each other to quantify the resin component in the supernatant obtained as a result of the third separation and to compare the precipitate obtained as a result of the second separation and the precipitate obtained as a result of the third separation. Thus, the adhesion between the colorant and the chargeable resin pseudo fine particles is observed.

To be specific, for example, the adhesion can be observed under the following conditions. 20 g of ink or a water dispersing element into which the colorant is dispersed are weighed and adjusted in such a manner that the total solid mass is about 10%. The resultant is subjected to the first separation at 12,000 rpm for 60 minutes by means of a centrifugal separator. After the separation, the precipitate in a lower layer containing the colorant is re-dispersed into pure water having an amount about 3 times as large as that of the precipitate. The dispersion is subjected to the second separation at 80,000 rpm for 90 minutes. The precipitate in a lower layer containing the colorant is re-dispersed into pure water having an amount 3 times as large as that of the precipitate. The dispersion is subjected to the third separation at 80,000 rpm for 90 minutes to take out the precipitate in the lower layer containing the colorant. About 0.5 g of each of the precipitate obtained as a result of the second separation and the precipitate obtained as a result of the third separation is weighed and dried under reduced pressure at 30° C. for 18 hours. The dried product is observed by means of a scanning electron microscope at a magnification of 50,000. Then, if the state where the observed dispersible colorant has multiple fine particle-like substances or fine aggregates comparable thereto adhering to its surface is observed, and the precipitate obtained as a result of the second separation and the precipitate obtained as a result of the third separation have similar forms, the colorant is judged to have resin pseudo fine particles adhering thereto. Furthermore, about one half the total volume of the supernatant in an upper layer obtained as a result of the third separation is taken from above, and is dried at 60° C. for 8 hours. A solid mass is calculated from a change in mass before and after the drying. If the change is less than 1%, probably no desorption of the resin pseudo fine particles from the dispersible colorant occurs, so the dispersible colorant is judged to have the resin pseudo fine particles adhering thereto.

The separation conditions described above are preferable examples, and any approach achieving the objects of the first separation, the second separation, and the third separation is applicable as a method of judging whether a colorant is the dispersible colorant to be used in the present invention by means of any other separation method or under any other separation condition. That is, the first separation is intended for separating the colorant in ink or a water dispersing element and a resin component adsorbing to the colorant, and a water-soluble component. The second separation is intended for separating the colorant and the resin component adhering thereto, and any other resin component adsorbing to the colorant. The third separation is intended for confirming that the resin component adhering to the colorant does not desorb. Of course, any other conventionally known separation approach or any other separation approach to be newly developed may adopted as long as it is capable of achieving the respective objects of the first separation, the second separation, and the third separation, and may have the number of stages of separation larger than 3 or smaller than 3.

A second feature of the dispersible colorant to be used in the present invention lies in that the dispersible colorant can be singly dispersed into an aqueous medium while the chargeable resin pseudo fine particles 2 fix to the water-insoluble colorant 1. As described above, the dispersible colorant to be used in the present invention is essentially a self-dispersible colorant which can be stably dispersed into water or aqueous ink without the aid of any other surfactant, polymer dispersant, or the like. The definition of, and a method of judging, the self-dispersible colorant will be described later. Accordingly, the dispersible colorant to be used in the present invention eliminates the need for adding a polymer dispersant, or any other resin component or surfactant component, which may desorb after a long period of time, for the purpose of stabilizing the dispersion of the colorant. As a result, when the dispersible colorant to be used in the present invention is used as aqueous ink, the degree of freedom of design with respect to any component except the dispersible colorant increases. Accordingly, for example, aqueous ink capable of providing a sufficiently high printing density even in a recording medium having high penetrability of ink such as plain paper can be obtained.

The self-dispersibility of the dispersible colorant to be used in the present invention can be confirmed, for example, as follows. The ink or water dispersing element into which the colorant is dispersed is diluted with pure water by 10-fold, and the dilution is concentrated to the original concentration by means of an ultrafiltration filter having a molecular cutoff of 50,000. The concentrate is separated at 12,000 rpm for 2 hours by means of a centrifugal separator, and the precipitate is taken out and re-dispersed into pure water. At this time, the precipitate that can be favorably re-dispersed is judged to have self-dispersibility. Whether the precipitate is favorably re-dispersed can be generally determined depending on, for example, whether the precipitate is apparently and evenly dispersed, whether no remarkable precipitate occurs during 1 to 2 hours of left standing, whether such remarkable precipitate, if any, can be dissolved with slight shaking, and whether the average particle size is twice or less as large as the particle size before operation when the dispersion particle size is measured by means of dynamic light scattering.

As described above, the dispersible colorant to be used in the present invention has a high specific surface area because the chargeable resin pseudo fine particles fix to the colorant, and has large charge on its wide surface, thereby realizing excellent storage stability. Therefore, a further preferable result is obtained when a large number of chargeable resin pseudo fine particles intersperse in and fix to the colorant. In particular, the adhering chargeable resin pseudo fine particles are desirably arranged at certain intervals and, preferably, evenly dispersed. Further preferably, the particle surface of the colorant is partly exposed between the chargeable resin pseudo fine particles. Such form is confirmed by observing the aqueous ink according to the present invention with a transmission electron microscope or a scanning electron microscope. That is, a state where multiple chargeable resin pseudo fine particles fix to the surface of the colorant at certain intervals or a state where the surface of the colorant is exposed between the adhering chargeable resin pseudo fine particles can be observed. The chargeable resin pseudo fine particles are partly adjacent to each other or fused with each other in some cases. Even in such cases, when, in general, there is a distance between any two of the chargeable resin pseudo fine particles or the surface of the colorant is exposed, and such states are distributed, it is apparent to one skilled in the art that the chargeable resin pseudo fine particles are regarded as interspersing in and adhering to the colorant.

Furthermore, an aqueous ink containing the dispersible colorant to be used in the present invention having the above features is found to exhibit excellent quick drying property on a recording medium. Although the reason for the finding is unclear, the finding is probably based on the following mechanism. As described above, the dispersible colorant is dispersed into the ink in a state where the chargeable resin pseudo fine particles fix to the surface of the colorant. When the ink reaches the recording medium, an aqueous solvent in the ink (hereinafter, the ink solvent) is absorbed by pores on the recording medium by virtue of capillarity (the pores are gaps between cellulose fibers in the case of plain paper, or pores of a receiving layer in the case of coated paper or glossy paper). At this time, because of the morphological feature of the dispersible colorant to be used in the present invention, the chargeable resin pseudo fine particles intersperse at portions where colorants are adjacent to each other to form a large number of fine gaps. Accordingly, the capillarity acts on the ink solvent present between colorants, so the ink solvent is quickly absorbed in the recording medium. The quick drying property is expected to be achieved with the mechanism described above on the basis of the fact that the aqueous ink according to the present invention using the colorant having the chargeable resin pseudo fine particles interspersing on its surface exhibits more preferable quick drying property.

The surface functional group density of the dispersible colorant according to the present invention is preferably 250 μmol/g or more and less than 1,000 μmol/g, or more preferably 290 μmol/g or more and less than 900 μmol/g. The long-term storage stability of the dispersible colorant may deteriorate when the dispersible colorant has a surface functional group density smaller than the range. When the dispersible colorant has a surface functional group density much larger than the range, the dispersion stability is so high that the dispersible colorant is apt to penetrate on a recording medium, and a high printing density is hardly secured in some cases. In the case where carbon black is used as the colorant, the surface functional group density of the colorant is preferably set to 350 μmol/g or more and less than 800 μmol/g because the specific gravity of carbon black is high and hence the dispersion stability must be enhanced, and because particularly a black density on a recording medium is preferably high.

The surface functional group density is determined, for example, as follows. First, a large excessive amount of an aqueous solution of hydrochloric acid (HCl) is added to a water dispersing element or ink containing a dispersible colorant to be measured, and the whole is centrifuged at 20,000 rpm for 1 hour by means of a centrifugal separator for precipitation. The precipitate is recovered and re-dispersed into pure water, and a solid fraction is determined by means of a drying process. The re-dispersed precipitate is weighed. A known amount of sodium hydrogen carbonate is added, and the whole is stirred to prepare a dispersion. The dispersion is additionally centrifuged at 80,000 rpm for 2 hours by means of a centrifugal separator for precipitation. The supernatant is weighed, and a neutralization amount is determined from neutralization titration by means of 0.1N hydrochloric acid. The known amount of sodium hydrogen carbonate is subtracted from the neutralization amount to determine the surface functional group density as a number of moles per 1 g of the colorant.

Next, the respective components constituting the dispersible colorant to be used in the present invention will be described.

[Colorant]

A colorant, which is one of the components of the dispersible colorant to be used in the present invention, will be described hereinafter. Out of the conventionally known colorants and the colorants to be newly developed, a colorant which is insoluble in water and can be stably dispersed into water together with a dispersant is desirably used as the colorant to be used in the present invention. Examples of such colorant include a hydrophobic dye, an inorganic pigment, an organic pigment, a metal colloid, and a colored resin fine particle. A colorant having a dispersion particle size in the range of preferably 0.01 to 0.5 μm (10 to 500 nm), or particularly preferably 0.03 to 0.3 μm (30 to 300 nm) is used. The dispersible colorant using a colorant having a dispersion particle size in such range becomes a preferable dispersible colorant which provides an image having high coloring power and high weatherability when the dispersible colorant is used as aqueous ink. Such dispersion particle size is a cumulant average value of particle sizes measured by means of dynamic light scattering.

Examples of an inorganic pigment that can be effectively used as the colorant in the present invention include carbon black, titanium oxide, zinc white, zinc oxide, tripon, iron oxide, cadmium red, molybdenum red, chrome vermilion, molybdate orange, chrome yellow, chrome yellow, cadmium yellow, yellow oxide, titanium yellow, chromium oxide, pyridian, cobalt green, titanium cobalt green, cobalt chrome green, ultramarine blue, ultramarine blue, Prussian blue, cobalt blue, cerulean blue, manganese violet, cobalt violet, and mica.

Examples of an organic pigment that can be effectively used in the present invention include various pigments such as azo-based, azomethine-based, polyazo-based, phthalocyanine-based, quinacridone-based, anthraquinone-based, indigo-based, thioindigo-based, quinophthalone-based, benzimidazolone-based, isoindoline-based, and isoindolinone-based pigments.

Examples of other organic insoluble colorants that can be used in the present invention include hydrophobic dyes such as azo-based, anthraquinone-based, indigo-based, phthalocyanine-based, carbonyl-based, quinoneimine-based, methine-based, quinoline-based, and nitro-based dyes. Of those, a dispersible dye is particularly preferable.

The investigation made by the inventors of the present invention has revealed that, when the colorant constituting the dispersible colorant in the aqueous ink of the present invention is a colorant having a hydrophilic group on its surface, ink particularly excellent in bleed resistance against any other ink while having excellent printing quality can be obtained. This is probably because the colorant originally has a hydrophilic group on its surface to prevent the adsorption of a surfactant, a penetrating agent, a water-soluble polymer component, or the like constituting the ink, thereby enhancing an image forming effect of a bad medium on the recording medium.

A colorant having a large number of hydroxyl groups, carbonyl groups, carboxyl groups, or the like on its surface (for example, carbon oxide as carbon black) is preferably used as a colorant having a hydrophilic group on its surface. In addition, a self-dispersible pigment which enhances the dispersibility of a water-soluble colorant itself and can be dispersed without the use of a dispersant or the like is particularly preferably used. Examples of the self-dispersible pigment include pigments each having a hydrophilic group chemically bonded to the surface of the pigment directly or via another atomic group. For example, a pigment having one selected from the group consisting of —COOM¹, —SO₃M¹, and —PO₃H(M¹)₂ (where M¹ represents a hydrogen atom, an alkali metal, ammonium, or organic ammonium) introduced to its surface can be suitably used. Furthermore, the other atomic group is preferably an alkylene group having 1 to 12 carbon atoms, a substituted or unsubstituted phenylene group, or a substituted or unsubstituted naphthylene group. More specifically, —C₂H₄—COOM¹, —Ph—SO₃M¹, and —Ph—COOM¹ (where Ph represents a phenyl group) can be suitably used.

An example of a method of directly introducing a hydrophilic group to the surface of a colorant includes a wet oxidation method. The method involves: impregnating an aqueous phase with a colorant; and adding an oxidant such as a peroxodi acid or a peroxodi acid salt to react the mixture at about 60 to 90° C. for surface oxidation. More specifically, wet oxidation for such colorant, especially carbon black can be performed by, for example, the method described in Japanese Patent Application Laid-Open No. 2003-183539.

Another example of wet oxidation is a method as described in Japanese Patent Application Laid-Open No. 2003-96372 involving the use of a hypochlorite such as sodium hypochlorite or potassium hypochlorite for oxidation. Carbon to be oxidized at this time is preferably carbon which is relatively hydrophilic such as gas black or acidic black because it can be oxidized more evenly. In addition, a method involving oxidizing carbon through underwater ozonization, a method involving: subjecting carbon black to ozonization; and subjecting carbon black to wet oxidation to modify the surface of carbon black, and the like can also be suitably used.

On the other hand, an example of a method of introducing a hydrophilic group to the surface of a colorant via another atomic group includes a method involving diazotizing p-aminobenzenesulfonic acid and allowing the resultant to react with the colorant. Of course, the present invention is not limited thereto. The colorant does not desirably have primary amine in order to suppress a side reaction in the introduction of a hydrophilic functional group by means of diazotization described above.

Here, in the above case, the dispersible colorant of the present invention further has a hydrophilic group (surface charge) based on chargeable resin pseudo fine particles. A hydrophilic group directly bonded to the colorant described above and a hydrophilic group which the pseudo fine particles have can be separated and distinguished from each other as follows.

The ink containing the dispersible colorant of the present invention is separated at 12,000 rpm for 60 minutes by means of a centrifugal separator. After the separation, the precipitate in a lower layer containing the colorant is taken out and placed into an organic solvent having high solubility with respect to a resin such as toluene or acetone to dissolve the precipitate. Therefore, the adhering or fusing chargeable resin pseudo fine particles are dissolved, so they desorb from the dispersible colorant and the colorant itself is present in the organic solvent. Next, the solution is rotated 80,000 times by means of a centrifugal separator to precipitate and separate the colorant. Then, the colorant is washed before being re-dispersed into pure water.

The colorant taken out of the ink of the present invention can be re-dispersed according to the method described above to measure surface charge. On the other hand, when a surfactant or a dispersant such as a polymer resin is adsorbed, more specifically in the case of a water dispersing element or ink obtained by conventional microencapsulation, the adsorbed component is dissolved when the precipitate is placed into the organic solvent, and desorbs from the water-insoluble colorant. As a result, the colorant cannot be re-dispersed into pure water, thereby making it impossible to measure the surface charge of the water-insoluble colorant itself in the present invention.

Furthermore, the degree of hydrophilicity (oxidation) of the surface of such colorant can be evaluated as the heating loss of the colorant (volatile content (%)). The heating loss in the present invention is preferably in the range of 2 mass % and 20 mass % (both inclusive). When the heating loss is smaller than the above range, the hydrophilicity of the surface of the colorant is low, so sufficient dispersion stability is not obtained by the colorant alone in some cases. When the heating loss is larger than the above range, quality such as a sufficient image density or sufficient bleed resistance is not obtained in some cases.

The degree of oxidation of the surface of such carbon black is evaluated as the volatile content (%) of carbon black. In general, when carbon black is heated to about 1,000° C. in a vacuum, a gas is generated according to a kind of a functional group present on the surface. The kind and amount of the surface functional group can be determined by analyzing the total amount or kind of the gas. It is understood that the higher the total sum of the heating loss is, the larger amount of hydrophilic groups carbon has. In general, a pigment has nearly no hydrophilic group such as a carboxyl group or a hydroxyl group on its surface, and in the case of carbon black, the volatile content of hydrophobic carbon black according to an ordinary furnace method is 2 mass % or less.

(Chargeable Resin Pseudo Fine Particles)

The chargeable resin pseudo fine particles, which are the other components of the dispersible colorant to be used in the present invention, are defined as a microbody obtained by the agglomeration of resin components each of which: is substantially insoluble in water; has a small dispersion unit (dispersion particle size) in water (or ink) of a colorant to which the components fix; and has a sufficiently high degree of polymerization. The microbody is virtually close to a spherical body, or the sizes of multiple microbodies (the chargeable resin pseudo fine particles) match with each other in a certain range. The resin components constituting the chargeable resin pseudo fine particles are preferably physically or chemically cross-linked with each other. Whether the resin components constituting the chargeable resin pseudo fine particles are cross-linked with each other can be confirmed by means of, for example, the following approach. The resin components constituting the chargeable resin pseudo fine particles are estimated in advance by means of a conventional analysis method. Linear polymers having the same chemical structure (or the same monomer unit composition) are synthesized by means of solution polymerization, and the chargeable resin pseudo fine particles and the polymers are impregnated with an organic solvent as a good medium to the polymers to compare the solubilities of the particles and polymers. When the solubility of each of the chargeable resin pseudo fine particles is lower than that of each of the polymers, it is confirmed that the chargeable resin pseudo fine particles are cross-linked inside them.

As another preferable embodiment, the cumulant average value of the dispersion particle sizes of the chargeable resin pseudo fine particles in water, if measurable by means of dynamic light scattering, is desirably in the range of 10 nm to 200 nm (both inclusive). The polydispersity index of the dispersion particle sizes is preferably less than 0.2 from the viewpoint of long-term storage stability of the dispersible colorant. When the center value of the dispersion particle sizes is larger than 200 nm or the polydispersity index is larger than 0.2, an original object, that is, to finely disperse, and stabilize the dispersion of, the colorant cannot be sufficiently achieved in some cases. When the average value of the dispersion particle sizes is smaller than 10 nm, the forms as the chargeable resin pseudo fine particles cannot be maintained sufficiently, and the resin is apt to be dissolved into water, so no merit of the present invention is obtained in some cases. On the other hand, the stabilization of dispersion of the colorant by the adhesion of the chargeable resin pseudo fine particles in the present invention is effectively expressed when the average value is in the range of 10 nm to 200 nm (both inclusive) and the diameters of the chargeable resin pseudo fine particles are smaller than those of the colorant particles themselves. The above preferable embodiment holds true for the case where the dispersion particle sizes of the chargeable resin pseudo fine particles cannot be measured, and in such case, the average particle size of the chargeable resin pseudo fine particles determined as a result of observation with an electron microscope may be in the range described above or a range comparable thereto.

In addition, when the colorant is an organic pigment, on condition that the above range is satisfied, the size of each of the chargeable resin pseudo fine particles is particularly desirably smaller than the dispersion particle size of the pigment and larger than the size of the colorant molecule as described above because a dispersible colorant having an extremely stable structure and high dispersibility can be obtained.

The term “chargeable” as used herein refers to a state where a chargeable one holds a certain form of ionized functional group in an aqueous medium, or desirably is self-dispersible because of its chargeability. Accordingly, whether the particles are chargeable resin pseudo fine particles can be confirmed by a method involving measuring the surface zeta potential of each of the chargeable resin pseudo fine particles by any one of conventionally known and arbitrary approaches, a method involving: performing potentiometric titration by means of an approach to be described later; and calculating the chargeability as a functional group density, a method involving adding an electrolyte to the water dispersing element of the chargeable resin pseudo fine particles to confirm the dependence of the dispersion stability on the electrolyte concentration, or a method involving performing chemical structural analysis of the chargeable resin pseudo fine particles by means of a conventional approach to examine the presence or absence of an ionic functional group.

Any resin components composed of, for example, natural or synthetic polymers to be generally used and polymers to be newly developed for the present invention can be used as the resin components constituting the chargeable resin pseudo fine particles without any limitation. Examples of an available resin component include an acrylic resin, a styrene/acrylic resin, a polyester resin, a polyurethane resin, a polyurea resin, a polysaccharide, and a polypeptide. In particular, a polymer or copolymer of a monomer component having a radical polymerizable unsaturated bond to which an acrylic resin or a styrene/acrylic resin belongs can be preferably used because it can be generally used and simplifies the functional design of the chargeable resin pseudo fine particles.

A monomer having a radical polymerizable unsaturated bond (hereinafter, referred to as the radical polymerizable monomer or, simply, the monomer) is preferably used in the present invention. Examples thereof include hydrophobic monomers including: (meth)acrylates such as methyl acrylate, ethyl acrylate, isopropyl acrylate, n-propyl acrylate, n-butyl acrylate, t-butyl acrylate, benzyl acrylate, methyl methacrylate, ethyl methacrylate, isopropyl methacrylate, n-propyl methacrylate, n-butyl methacrylate, isobutyl methacrylate, t-butyl methacrylate, tridecyl methacrylate, and benzyl methacrylate; styrene-based monomers such as styrene, α-methylstyrene, o-methylstyrene, m-methylstyrene, p-methylstyrene, and p-tert-butylstyrene; itaconates such as benzyl itaconate; maleates such as dimethyl maleate; fumarates such as dimethyl fumarate; acrylonitrile; methacrylonitrile; and vinyl acetate. In the present invention, the term “(meth)acrylic acid” refers to methacrylic acid and acrylic acid.

Such hydrophilic monomers as described below are also preferably used. Examples thereof include monomers each having an anionic group including: monomers each having a carboxyl group such as acrylic acid, methacrylic acid, crotonic acid, ethacrylic acid, propyl acrylic acid, isopropyl acrylic acid, itaconic acid, and fumaric acid, and salts of them; monomers each having a sulfonic group such as styrenesulfonic acid, sulfonic acid-2-propylacrylamide, acrylic acid-2-ethyl sulfonate, methacrylic acid-2-ethyl sulfonate, and butyl acrylamide sulfone, and salts of them; and monomers each having a phosphonic acid group such as methacrylic acid-2-ethyl phosphonate and acrylic acid-2-ethyl phosphonate. Of those, acrylic acid or methacrylic acid is particularly preferably used.

Examples of monomers each having a cationic group include: monomers each having a primary amino group such as aminoethyl acrylate, aminopropyl acrylate, amide methacrylate, aminoethyl methacrylate, and aminopropyl methacrylate; monomers each having a secondary amino group such as methylaminoethyl acrylate, methylaminopropyl acrylate, ethylaminoethyl acrylate, ethylaminopropyl acrylate, methylaminoethyl methacrylate, methylaminopropyl methacrylate, ethylaminoethyl methacrylate, and ethylaminopropyl methacrylate; monomers each having a tertiary amino group such as dimethylaminoethyl acrylate, diethylaminoethyl acrylate, dimethylaminopropyl acrylate, diethylaminopropyl acrylate, dimethylaminoethyl methacrylate, diethylaminoethyl methacrylate, dimethylaminopropyl methacrylate, and diethylaminopropyl methacrylate; monomers each having a quaternary ammonium group such as acrylic acid dimethylaminoethylmethylchloride salt, methacrylic acid dimethylaminoethylmethylchloride salt, acrylic acid dimethylaminoethylbenzylchloride salt and methacrylic acid dimethylaminoethylbenzylchloride salt; and various vinyl imidazoles.

To be specific, monomers each having simultaneously a radical polymerizable unsaturated bond and a hydroxyl group showing strong hydrophilicity in its structure correspond to nonionic and hydrophilic monomers. Hydroxyethyl (meth)acrylate, hydroxypropyl (meth)acrylate, and the like are classified into the monomers. In addition, various conventionally known or novel oligomers, macromonomers, and the like can also be used without any limitation.

The investigation by the inventors of the present invention has revealed that, particularly when the chargeable resin pseudo fine particles contain at least a polymer obtained by polymerizing at least a monomer represented by the following formula (1) out of the above monomers, aqueous ink which provides a high printing density at all times and has excellent quick drying property can be obtained.
CH₂═C(R¹) COO(R²O)ₙR³ (1)
(In the formula, R¹ represents a hydrogen atom or an alkyl group having 1 to 5 carbon atoms, R² represents a divalent hydrocarbon group having 1 to 30 carbon atoms which may have a hetero atom, R³ represents a hydrogen atom or a monovalent hydrocarbon group having 1 to 30 carbon atoms which may have a hetero atom, and n represents a number of 1 to 60.)

Representative examples of the monomers each represented by the formula (1) include polyethylene glycol (meth)acrylate, methoxy polyethylene glycol (1 to 30: this indicates the value of n in the formula (1). The same holds true for the following.) (meth)acrylate, methoxy polytetramethylene glycol (1 to 30) (meth)acrylate, ethoxy polyethylene glycol (1 to 30) (meth)acrylate, (iso)propoxy polyethylene glycol (1 to 30) (meth)acrylate, butoxy polyethylene glycol (1 to 30) (meth)acrylate, methoxy polypropylene glycol (1 to 30) (meth)acrylate, and methoxy (ethylene glycol/propylene glycol copolymerization) (1 to 30: ethylene glycol therein: 1 to 29) (meth)acrylate each having a hydrogen atom at a terminal thereof. Each of them may be used alone, or two or more of them may be used in combination. Of those, methoxy polyethylene glycol (1 to 30) (meth)acrylate having a hydrogen atom at a terminal thereof and having a methyl group or an ethyl group is preferable.

Of the monomers each represented by the formula (1), methoxy terminal polyethylene glycol (4 mol) methacrylate [for example, trade name: NK Ester M-40G, manufactured by Shin-Nakamura Chemical Co., Ltd.], methoxy terminal polyethylene glycol (9 mol) methacrylate [for example, trade name: NK Ester M-90G, manufactured by Shin-Nakamura Chemical Co., Ltd.], methoxy terminal polyethylene glycol (2 mol) methacrylate [for example, trade name: NK Ester M-230G, manufactured by Shin-Nakamura Chemical Co., Ltd.], methoxy terminal polyethylene glycol (9 mol) acrylate [for example, trade name: NK Ester AM-90G, manufactured by Shin-Nakamura Chemical Co., Ltd.], phenoxy terminal polyethylene glycol (6 mol) acrylate [for example, trade name: NK Ester AMP-60G, manufactured by Shin-Nakamura Chemical Co., Ltd.], hydroxyl group terminal polyethylene glycol (5 mol) methacrylate [for example, trade name: MA-50, manufactured by Nippon Nyukazai, Co., Ltd.], and hydroxyl group terminal polyethylene glycol (10 mol) methacrylate [for example, trade name: MA-100, manufactured by Nippon Nyukazai, Co., Ltd.]. Of those, methoxy terminal polyethylene glycol methacrylate is more preferable because more excellent dispersion stability and a higher printing density can be obtained, and the number of oxyethylenes in the polyethylene glycol chain is still more preferably 4 to 9.

When the chargeable resin pseudo fine particles contain at least a polymer obtained by polymerizing at least a monomer represented by the formula (1), the content of the polymer in the entire chargeable resin pseudo fine particles is preferably 1 mass % or more and less than 70 mass %, or more preferably 3 mass % or more and less than 60 mass % from the viewpoint of the morphological stability of the chargeable resin pseudo fine particles in the aqueous ink.

Various properties of the dispersible colorant and the chargeable resin pseudo fine particles can be appropriately controlled by a large number of control factors such as the kinds and copolymerization ratio of monomers constituting the chargeable resin pseudo fine particles and the kind and concentration of a polymerization initiator to be used at the time of preparation of the polymer. The chargeable resin pseudo fine particles are each particularly desirably composed of a copolymer of monomer components containing at least one kind of hydrophobic monomer and at least one kind of hydrophilic monomer out of the monomers listed above. At this time, the chargeable resin pseudo fine particles are each composed by using at least one kind of hydrophobic monomer, whereby good adhesiveness to a colorant and good thermal stability can be imparted. Similarly, the chargeable resin pseudo fine particles are each composed by using at least one kind of hydrophilic monomer, whereby good morphological control and good dispersion stability can be imparted. Therefore, the simultaneous use of those monomers provides chargeable resin pseudo fine particles which favorably fix to the colorant at all times and have good dispersion stability. On condition that the above conditions are satisfied, by appropriately selecting the kinds and copolymerization ratio of monomers of the resin components constituting the chargeable resin pseudo fine particles, additional functionality can be imparted to the dispersible colorant and/or the chargeable resin pseudo fine particles adhering to the colorant according to the present invention.

For example, one containing at least a monomer having a methyl group at position a and having a radical polymerizable unsaturated double bond is also preferably used as the hydrophobic monomer. Eject property of aqueous ink containing a dispersible colorant becomes extremely good in a thermal ink jet method involving ejecting the ink by virtue of thermal energy by allowing chargeable resin pseudo fine particles using a radical polymerizable monomer having a methyl group at position a to fix. The reason therefor is unclear, but the following reason is conceivable. A resin using a radical polymerizable monomer having a methyl group at position a undergoes depolymerization at a high temperature, so the resin composed of the monomer component having a methyl group at position a undergoes depolymerization when thermal energy is applied to the ink, and the sticking inside a eject port hardly occurs, thereby improving eject property.

At least an alkyl acrylate compound and an alkyl methacrylate compound (hereinafter, referred to as alkyl (meth)acrylate compounds) are also preferably incorporated as the hydrophobic monomers. The alkyl (meth)acrylate compounds have good adhesiveness with a colorant and, at the same time, are excellent in copolymerizability with the hydrophilic monomer components, thereby providing preferable results from the viewpoints of uniformity of surface properties of the chargeable resin pseudo fine particles and uniform adhesiveness with a colorant.

At least one kind chosen from benzyl methacrylate and methyl methacrylate out of the preferable hydrophobic monomers described above is particularly preferably incorporated. In addition to the above-described reason why doing so is preferable, the above two kinds of monomers impart preferable heat resistance and transparency to the chargeable resin pseudo fine particles, so the dispersible colorant obtained by allowing the chargeable resin pseudo fine particles to fix exhibits excellent color developability.

As described above, the properties of the dispersible colorant and/or the chargeable resin pseudo fine particles adhering to the colorant of the present invention can be controlled by appropriately selecting the kinds and copolymerization ratio of monomers constituting the chargeable resin pseudo fine particles. The glass transition temperature of each of the copolymer components in the chargeable resin pseudo fine particles is controlled to −40° C. or higher and 60° C. or lower, preferably −30° C. or higher and 55° C. or lower, or more preferably −25° C. or higher and 53° C. or lower. To obtain such chargeable resin pseudo fine particles, a monomer from which a homopolymer known to have a low glass transition temperature is produced is selected from the above-described group of monomers to be preferably used. For example, in a preferred embodiment, n-butyl acrylate and acrylic acid are used as monomers at an appropriate ratio. In another preferred embodiment, ethyl methacrylate and methacrylic acid are used as monomers at an appropriate ratio.

A dispersible colorant containing a copolymer component having a glass transition temperature of −40° C. or higher and 60° C. or lower forms a film with an adjacent colorant on recording paper by virtue of high film formability imparted to chargeable resin pseudo fine particles, so it is capable of forming a strong colored film. Therefore, high abrasion resistance is imparted to a printed matter obtained by using the dispersible colorant having such constitution. In addition, a printed matter excellent in abrasion resistance can be obtained even on a glossy recording medium extremely disadvantageous to abrasion resistance.

The glass transition temperature of each of chargeable resin pseudo fine particles can be measured according to the following procedure. A dispersible colorant is subjected to acid precipitation with hydrochloric acid or the like to recover the precipitate. Furthermore, the precipitate is subjected to Soxhlet extraction by means of an organic solvent such as tetrahydrofuran (THF). Then, the organic solvent is distilled off to prepare chargeable resin pseudo fine particles adhering to a colorant. The resultant chargeable resin pseudo fine particle components are subjected to differential scanning calorimetry to measure the glass transition temperature. For example, a DSC822e manufactured by METTLER-TOLEDO International Inc. is desirably used. A water dispersion containing a dispersible colorant and a water-soluble nonionic resin at the same time can be separated by means of a centrifugal separator. For example, when the water dispersion is centrifuged at 12,000 rpm, the dispersible colorant can be obtained as a precipitate.

(Synthesis of Chargeable Resin Pseudo Fine Particles and Adhesion to Colorant)

Synthesis of the chargeable resin pseudo fine particles and adhesion to the colorant can be performed by a method of synthesizing chargeable resin pseudo fine particles whose procedure and method are known and a method of combining chargeable resin pseudo fine particles and a colorant. Meanwhile, the inventors of the present invention have made extensive studies to invent a method of producing a dispersible colorant having a colorant and chargeable resin pseudo fine particles each of which is smaller than the colorant in which the chargeable resin pseudo fine particles fix to the colorant, which is characteristic of the present invention. Hereinafter, a preferable method of producing a dispersible colorant with which the dispersible colorant to be used in the present invention can be easily obtained will be described. A dispersing element itself is prepared in the case of a self-dispersible colorant.

The inventors of the present invention have made extensive studies to reveal that the dispersible colorant to be used in the present invention having such properties as described above can be extremely easily produced by applying aqueous precipitation polymerization method under the following conditions. The production method involves: dispersing a water-insoluble colorant by means of a dispersant to prepare an aqueous solution into which the water-insoluble colorant is dispersed; and allowing chargeable resin pseudo fine particles to fix to the colorant in the aqueous solution through a step of subjecting a radical polymerizable monomer to aqueous precipitation polymerization by means of an aqueous radical polymerization initiator. The dispersible colorant obtained through the step of aqueous precipitation polymerization is a water-insoluble colorant in which the chargeable resin pseudo fine particles synthesized in the course of the aqueous precipitation polymerization are uniformly interspersed and strongly fix to the colorant, so it is excellent in dispersion stability in a single body. In addition, in the course of the aqueous precipitation polymerization, the properties of the chargeable resin pseudo fine particles can be easily controlled to such preferable forms as described above. At that time, the adhesion state of the colorant and the chargeable resin pseudo fine particles, which is characteristic of the present invention, is favorably achieved. Hereinafter, a preferred embodiment in the production method will be described in more detail.

(Dispersion of Water-Insoluble Colorant)

First, such water-insoluble colorant to be preferably used in the present invention as described above is dispersed into a dispersant to prepare a water dispersing element. Any one of ionic, nonionic, and like other dispersants can be used for dispersing the colorant into an aqueous solution. Of those, a polymer dispersant or a water-soluble polymer is desirably used from the viewpoint of maintaining dispersion stability in any subsequent polymerization step. One exhibiting sufficient water solubility and having hydrophobic portions serving as adsorption sites to the surface of a colorant fine particle and to an oil droplet interface of a radical polymerizable monomer to be added in a polymerization step, especially a hydrophobic monomer, is particularly preferably used. At least one kind of hydrophobic monomer to be used in any subsequent polymerization step is further desirably present as a unit constituting a dispersant because the adhesion of the chargeable resin pseudo fine particles to the colorant in any subsequent polymerization step can be easily induced.

Methods of producing a polymer dispersant and a water-soluble polymer each of which can function as a dispersant that can be used in the present invention are not particularly limited. For example, a polymer dispersant or a water-soluble polymer can be produced by allowing a monomer having an ionic group and another monomer polymerizable with the foregoing monomer to react with each other in a non-reactive solvent in the presence or absence of a catalyst. In particular, it has been revealed that good results can be obtained by using a dispersant selected from styrene/acrylic polymer compounds each obtained by polymerizing such monomer having an ionic group as described above and a styrene monomer as essential ingredients, and ionic group-containing acrylic polymer compounds each obtained by polymerizing a monomer having an ionic group and a (meth)acrylate monomer having 5 or more carbon atoms as essential ingredients. In the case where a dispersible colorant to be obtained aims at having, in particular, an anionic group, an anionic dispersant is desirably selected. On the other hand, in the case where a dispersible colorant to be obtained aims at having, in particular, a cationic group, a dispersant having a cationic group or a nonionic dispersant is desirably selected.

An anionic dispersant having an acid value of 100 or more and 250 or less, or a cationic dispersant having an amine value of 150 or more and 300 or less is desirably used for achieving compatibility between the promotion of the adhesion of the chargeable resin pseudo fine particles to the colorant and the maintenance of the dispersion stability of the colorant in a subsequent aqueous polymerization step. When each of the acid value and the amine value is smaller than the range, the affinity between the hydrophobic monomer and the dispersant becomes higher than the affinity between the colorant and the dispersant at the time of aqueous precipitation polymerization, so the chargeable resin pseudo fine particles desorb from the surface of the colorant before they fix to the colorant, and the state of dispersion cannot be maintained in some cases. When each of the acid value and the amine value is larger than the range, the excluded volume effect and electrostatic repulsion of the dispersant on the surface of the colorant become so strong that the adhesion of the chargeable resin pseudo fine particles to the colorant is inhibited in some cases. When an anionic dispersant is used, a dispersant having a carboxyl group as an anionic group is preferably selected because it does not inhibit the adhesion of the resin fine particles to the colorant.

In the course of turning a water-insoluble colorant into an aqueous dispersion by means of a dispersant, the dispersion particle size of the colorant is preferably 0.01 μm or more and 0.5 μm or less (10 nm or more and 500 nm or less), or particularly preferably 0.03 μm or more and 0.3 μm or less (30 nm or more and 300 nm or less). The dispersion particle size in this course is greatly reflected in the dispersion particle size of the dispersible colorant to be obtained. Therefore, the dispersion particle size is preferably within the aforementioned range from the viewpoints of the coloring power described above, the weatherability of an image, and the dispersion stability.

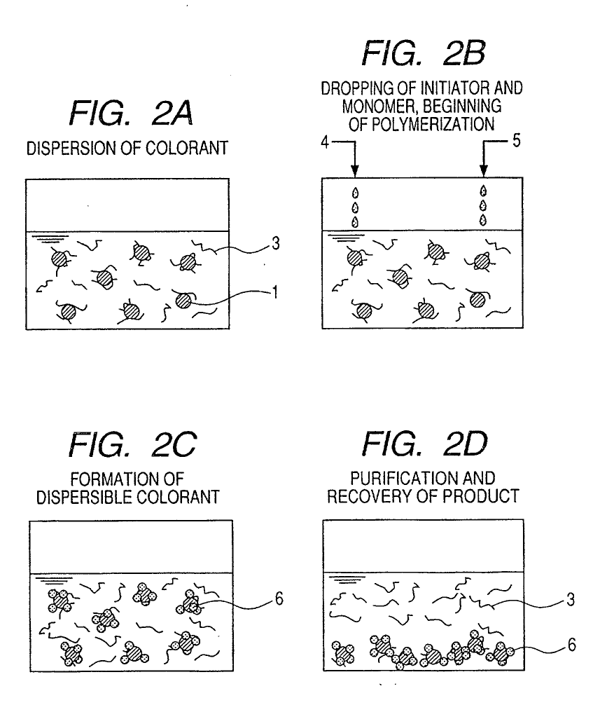

The dispersion particle size distribution of the water-insoluble colorant to be used in the present invention is preferably as monodisperse as possible. In general, the particle size distribution of the dispersible colorant obtained by the adhesion of the chargeable resin pseudo fine particles tends to be narrower than the particle size distribution of the aqueous dispersion prior to the polymerization step shown in FIG. 2B, but basically depends on the particle size distribution of the aqueous dispersion described above. In addition, it is important to narrow the particle size distribution of the colorant in order to surely induce the adhesion of the chargeable resin pseudo fine particles to the colorant by virtue of hetero agglomeration. According to the investigation by the inventors of the present invention, a colorant having a polydispersity index of 0.25 or less provides a dispersible colorant to be obtained with excellent dispersion stability.

The particle size of the colorant in a state of dispersion varies according to various measurement methods, and in particular, the number of cases where an organic pigment is composed of spherical particles is extremely small. In the present invention, the particle size was measured by means of an ELS-8000 manufactured by Otsuka Electronics Co., Ltd., and on the basis of dynamic light scattering. In addition, the average particle size and the polydispersity index determined by cumulant analysis were used.

A method of dispersing a water-insoluble colorant into water has only to be any one of such methods each involving the use of a dispersant as described above out of the methods with each of which the colorant can be stably dispersed into water under such conditions as described above, and is not limited to any one of the conventionally known methods. Alternatively, the method may be a dispersion method newly developed for the present invention. In general, for example, when the water-insoluble colorant is a pigment, the addition amount of a polymer dispersant to be used is suitably 10 mass % or more and 130 mass % or less with respect to the pigment.

Means for dispersing a colorant to be used in the present invention is not limited as long as it is generally used for each colorant, and examples thereof include: dispersing devices such as a paint shaker, a sand mill, an agitator mill, and a three-roll mill; high-pressure homogenizers such as a micro-fluidizer, a nanomizer, and an altimizer; and ultrasonic dispersing devices.

(Radical Polymerization Initiator)

Any radical polymerization initiator can be used in the present invention as long as it is a general water-soluble radical polymerization initiator. Specific examples of the water-soluble radical polymerization initiator include a persulfate and a water-soluble azo compound. Alternatively, the initiator may be a redox initiator obtained by combining a water-soluble radical polymerization initiator and a reducing agent. To be specific, a water-soluble radical polymerization initiator and a reducing agent are optimally combined in consideration of the properties of the colorant, dispersant, and monomer listed above. A polymerization initiator having a polymerization initiator residue having the same charge as that on the surface of a dispersible colorant to be obtained is desirably selected. That is, for example, when a water-insoluble colorant having an anionic group is to be obtained, an initiator having a neutral or anionic initiator residue is selected. With the selection, surface charge can be obtained with improved efficiency. Similarly, when a dispersible colorant having a cationic group is to be obtained, an initiator having a neutral or cationic initiator residue is preferably selected.

Any one of conventional water-soluble azo-based polymerization initiators generally used for emulsion polymerization and the like is preferably used in the present invention. Any other newly developed polymerization initiator to be used for emulsion polymerization can also be used. Examples thereof include VA-080 (2,2′-azobis(2-methyl-N-(1,1-bis(hydroxymethyl)-2-hydroxyethyl)propioneamide)), VA-086 (2,2′-azobis(2-methyl-N-(2-hydroxyethyl)propioneamide)), VA-057 (2,2′-azobis(N-(2-carboxyethyl)amidinopropane)), VA-058 (2,2′-azobis(2-(3,4,5,6-tetrahydropyrimidin-2-yl)propane)dihydrochloride), VA-060 (2,2′-azobis(2-(1-(2-hydroxyethyl)-2-imidazolin-2-yl)propane)dihydrochloride, V-50 (2,2′-azobis(2-amidinopropane)dihydrochloride), and V-501 (4,4′-azobis(4-cyanopentanoic acid)) (all of which are available from Wako Pure Chemical Industries, Ltd.).

(Radical Polymerizable Monomer)

The radical polymerizable monomer to be used for the production method of the present invention is subjected to the step of aqueous precipitation polymerization described above to serve as a component constituting the chargeable resin pseudo fine particles. Accordingly, as described in the section titled (Resin fine particle substantially insoluble in water), the monomer is desirably selected in a proper manner according to the properties of chargeable resin pseudo fine particles and a dispersible colorant to be obtained. In the production method of the present invention as well, any one of conventionally known radical polymerizable monomers and radical polymerizable monomers newly developed for the present invention can be used.

(Aqueous Precipitation Polymerization)

Subsequently, a preferred embodiment of the aqueous precipitation polymerization, which is a step involving synthesizing the chargeable resin pseudo fine particles which are characteristic of the present invention and allowing the particles to fix to the colorant, will be described. It should be noted that the present invention is not limited to the embodiment to be described later. FIGS. 2A, 2B, 2C, and 2D each schematically show a step flow of the production method. The course of obtaining a dispersible colorant through the steps is considered to be as follows. First, as shown in FIG. 2A, a colorant 1 is dispersed into an aqueous solution by means of a dispersant 3 to prepare an aqueous dispersion. At this time, the colorant is stably dispersed owing to adsorption of the dispersant, and the adsorption is in thermal equilibrium. Next, the aqueous dispersion prepared in FIG. 2A is heated while being stirred, and monomer components 4 are added to the dispersion together with, for example, an aqueous radical polymerization initiator 5 (see FIG. 2B). The added radical polymerization initiator is cleaved by heating to generate a radical which contributes to a reaction between a hydrophobic monomer dissolved in a trace amount in the aqueous phase and a water-soluble monomer in the aqueous phase out of the monomer components added to the aqueous dispersion.

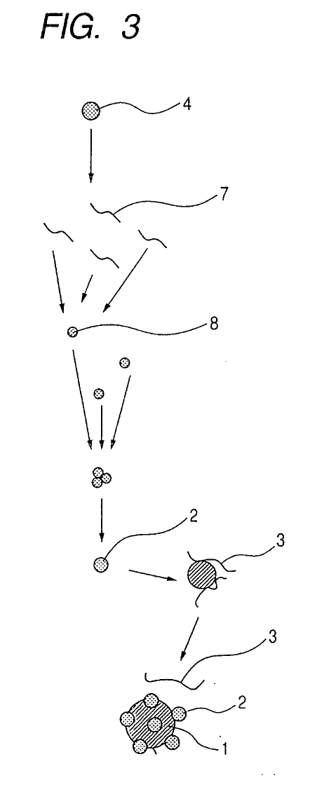

FIG. 3 is a schematic view showing the course in which the monomers 4 polymerize to produce a dispersible colorant. Once such reaction of the monomers 4 as described above proceeds, an oligomer 7 produced by the polymerization reaction of the monomer components becomes insoluble in water, and is precipitated as a precipitate 8 from the aqueous phase. However, the oligomer 7 precipitated at this time does not have sufficient dispersion stability, so it coalesces with another oligomer to form a chargeable resin pseudo fine particle 2. The chargeable resin pseudo fine particles 2 receive hetero agglomeration with the hydrophobic surface of the colorant in the aqueous dispersion as a core, so the surface of the colorant 1 and the resin components constituting the chargeable resin pseudo fine particles 2 strongly adsorb to each other by virtue of a hydrophobic interaction. At this time, a polymerization reaction continues to proceed inside the chargeable resin pseudo fine particles 2, so the particles are stabilized in terms of energy while they increase the number of points of adsorption to the colorant 1. At the same time, physical cross-linkings are formed inside the chargeable resin pseudo fine particles 2 to a high degree. As a result, the particles are in an adhesion state where they most stably adsorb to the colorant 1. Meanwhile, the colorant 1 is stabilized by the adhesion of the multiple chargeable resin pseudo fine particles 2 thereto, and the dispersant 3 in equilibrium desorbs from the surface of the colorant 1.

FIG. 4 is a schematic view showing the chargeable resin pseudo fine particles 2 thus obtained on the side of an interface at which they fix to the colorant 1. As shown in FIG. 4, a chargeable resin pseudo fine particle as an aggregate of resin components has a hydrophilic monomer unit 9-1, a hydrophobic monomer unit 9-2, and the like arbitrarily distributed therein. Therefore, the local surface energy of the particle has a distribution, and there are many points of adsorption 10 each having the surface energy coinciding with that of the colorant.

FIG. 5 is an enlarged schematic view showing an interface at which part of the chargeable resin pseudo fine particles 2 fix to part 1a of colorant. An interface 11 of the chargeable resin pseudo fine particles stably fixes to the part 1a of the colorant with its shape changed in accordance with the surface shape of the part 1a while it adsorbs the points of adsorption 10 shown in FIG. 4. As described above, in this process as well, a polymerization reaction proceeds inside the chargeable resin pseudo fine particles, so the particles fix to the colorant while being stably adsorbed to the colorant. Through the above process, the dispersible colorant having such constitution as described above is easily formed (see FIG. 2D). At this time, in a system where the chargeable resin pseudo fine particles achieve self-dispersibility while having sufficient surface charge, electrostatic repulsion acts between the chargeable resin pseudo fine particles in the processes of adsorption and adhesion to the colorant by virtue of hetero agglomeration. As a result, the chargeable resin pseudo fine particles are interspersed in and fix to the colorant, which is the preferred embodiment described above.

Polymerization reaction conditions, which vary depending on the characteristics of a polymerization initiator, dispersant, and monomer to be used, include a reaction temperature of 100° C. or lower (preferably 40° C. or higher and 80° C. or lower), a reaction time of 1 hour or more (preferably 6 hours or more and 30 hours or less), and a rate of stirring during a reaction of 50 rpm or more and 500 rpm or less (preferably 150 rpm or more and 400 rpm or less).

In particular, when monomer components each containing at least one kind of hydrophobic monomer and at least one kind of hydrophilic monomer are polymerized to produce chargeable resin pseudo fine particles in the above process, the monomer components are preferably added dropwise to an aqueous dispersion of a water-insoluble colorant containing an aqueous radical polymerization initiator in advance. The monomer components may be added simultaneously with the aqueous radical polymerization initiator to the aqueous dispersion of the water-insoluble colorant, or may be added dropwise to the dispersion separately from the initiator. To uniformly obtain desired chargeable resin pseudo fine particles from a mixture of monomers having different characteristics such as a hydrophobic monomer and a hydrophilic monomer, a copolymerization ratio of the monomers having different characteristics is desirably kept constant at all times. When an excessive amount of the mixture of the monomers is added with respect to the amount of monomers to be consumed for a polymerization reaction during a certain period of time, there is a tendency that only specific monomer species are polymerized in advance, and the remaining monomers are polymerized after the monomers polymerized in advance are consumed. In this case, the characteristics of chargeable resin pseudo fine particles to be produced show large unevenness. Particles each having a large content of hydrophilic monomer component out of the chargeable resin pseudo fine particles thus produced may be unable to fix to the surface of the colorant.

Furthermore, a resin component having a large content of hydrophilic monomer component cannot be precipitated owing to its high hydrophilicity, and remains as a water-soluble resin component without forming any chargeable resin pseudo fine particle in some cases. Chargeable resin pseudo fine particles constituted at a desired copolymerization ratio in which a copolymerization ratio between a hydrophobic monomer and a hydrophilic monomer is kept constant at all times can be uniformly obtained by adding dropwise monomer components to an aqueous dispersion of a water-insoluble colorant containing an aqueous radical polymerization initiator.

In particular, when an anionic monomer such as acrylic acid or methacrylic acid is added as a hydrophilic monomer to a polymerization system, the monomer may be partly destabilized depending on the properties of a polymer dispersant for dispersing a colorant to thereby agglomerate. To prevent this phenomenon, the anionic monomer is preferably neutralized in advance and added in the state of a sodium salt or a potassium salt.

In preparing aqueous ink by using the water-insoluble colorant according to the present invention obtained through the above steps in which the chargeable resin pseudo fine particles fix to the colorant, a purification treatment is desirably performed in addition to the above steps. In particular, in the foregoing, it is important to purify an unreacted polymerization initiator, monomer components, dispersant, water-soluble resin components and chargeable resin pseudo fine particle that did not fix, and the like in order to maintain the storage stability of the dispersible colorant at a high level. An optimum method can be selected from the purification methods generally used. For example, purification through centrifugation or ultrafiltration is also preferable.

Through the above steps, a dispersible colorant in which chargeable resin pseudo fine particles each composed of a desired copolymer fix to the surface of a colorant can be obtained by controlling a large number of control factors. In particular, when an anionic monomer is used for the purpose of obtaining high dispersion stability, the dispersible colorant that has passed the steps of the present invention can have a large surface functional group density even when the amount of the anionic monomer to be used in the above step is relative small. As a result, the dispersion stability of the chargeable resin pseudo fine particles can be increased without any damage to long-term storage stability.

Although the reason for the above is unclear, the inventors of the present invention consider as follows. When a radical generated in water initiates polymerization so that oligomers are precipitated to form chargeable resin pseudo fine particles, a portion having a large amount of components derived from an anionic monomer preferentially orients toward an aqueous phase, that is, the vicinity of the surfaces of the chargeable resin pseudo fine particles. This state is maintained even after the chargeable resin pseudo fine particles have fixd to a colorant. Furthermore, in the dispersible colorant to be used in the present invention having a structurally large specific surface area, a large number of anionic groups derived from an anionic monomer component are present. As a result, the dispersible colorant obtained by means of the production method described above is expected to stabilize with the aid of a reduced amount of anionic monomer components.

Next, a bad medium and a good medium to be used in the present invention will be described. Details about the definition of each of the bad and good media will be described later. A water-soluble organic solvent having good dispersion stability of a dispersible colorant is defined as a good medium, while a water-soluble organic solvent having bad dispersion stability of a dispersible colorant is defined as a bad medium. The present invention is further characterized in that: attention is paid to a dispersible colorant having the above-described specific shape and water-soluble organic solvents each of which is to be incorporated into aqueous ink together with the dispersible colorant; the water-soluble organic solvents are classified into one showing behavior as a bad medium with respect to the dispersible colorant and one showing behavior as a good medium with respect to the dispersible colorant; and the bad medium and the good medium are adjusted at a specific ratio in the aqueous ink. The inventors have found that such constitution has a significant effect in that an ink which: has excellent storage stability in the state of ink; can provide a high-quality image with little feathering or bleeding for a recording medium, especially for plain paper that has conventionally involved various problems in image formation by means of aqueous ink; can form an image which has a sufficiently large area factor even when an amount of ink droplet to be applied is small, and which has a high OD; and can provide an image excellent in abrasion resistance, marker resistance, and water resistance. Thus, the inventors have completed the present invention.

Although the reason why the present invention provides such effect is unclear, the inventors of the present invention consider as follows. In general, when an image is formed on recording paper such as plain paper by means of aqueous ink, a colorant must be left on the paper with improved efficiency in order to realize an excellent printing density and excellent printing quality. A method of realizing this involves: allowing a reaction solution to fix to recording paper; and then allowing a pigment ink composition to fix to the recording paper to obtain an excellent printing density and excellent printing quality. Another method involves the use of a special dispersant to achieve compatibility between the achievement of storage stability of ink and the achievement of a high printing density. However, according to the investigation by the inventors of the present invention, a sufficient printing density is hardly obtained with any one of those methods, and, in particular, a high printing density, and excellent abrasion resistance, excellent marker resistance, and excellent water resistance cannot be achieved at high levels at the same time.

The aqueous ink according to the present invention contains at least: water; a dispersible colorant; and multiple water-soluble organic solvents, the aqueous ink containing a good medium with respect to the dispersible colorant and a bad medium with respect to the dispersible colorant as the water-soluble organic solvents. When such aqueous ink is in the state of ink, water, the water-soluble organic solvents containing the good and bad media with respect to the dispersible colorant, and the dispersible colorant are mixed at a predetermined ratio, and storage stability is maintained by high dispersion stability of the dispersible colorant and the ratio between the good medium and the bad medium.

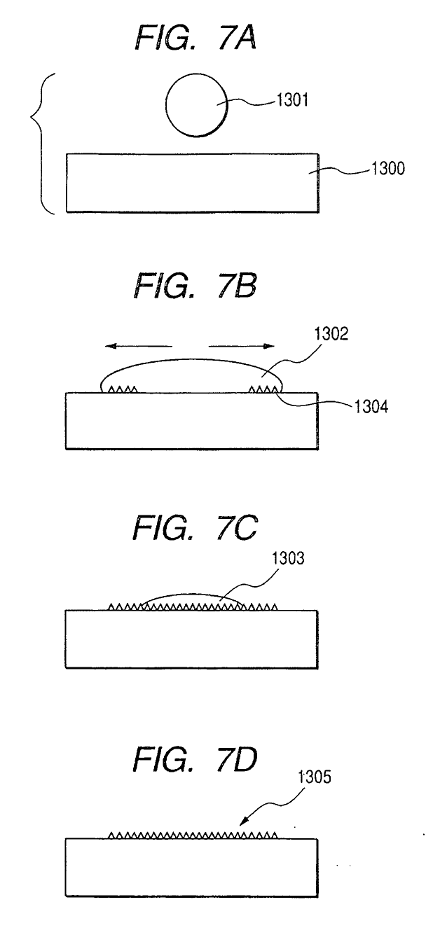

When a letter is printed by means of the aqueous ink according to the present invention on a recording medium, especially on plain paper, an extremely excellent printing density and extremely excellent printing quality may be obtained because of the following reason. That is, as shown in FIG. 7A, in the case where an ink droplet 1301 according to the present invention is printed on a recording medium 1300 (such as plain paper), the ratio among water, the good and bad media with respect to the dispersible colorant, and the dispersible colorant in the ink changes from the point of time at which the ink impinges on the recording medium. In other words, once the ink droplet impinges on the surface of the recording medium, a bad medium having a high Ka value out of the water-soluble organic solvent in the ink rather than a good medium having a low Ka value radially spreads over the recording mediaimultaneously with the evaporation of water, thereby forming an ink dot. When attention is paid to the state of spreading of the ink dot in this case, the concentration of the bad medium is expected to be higher at an outer periphery 1302 of the dot than at a center portion 1303 of the dot. As a result, a sudden increase in concentration of the bad medium with respect to the dispersible colorant occurs in the course in which the ink dot radially spreads over the recording medium. The sudden increase involves the emergence of: the destabilization of the dispersible colorant; and the agglomeration or dispersion breakage of the dispersible colorant as a colorant. As a result, a dispersible colorant 1304 remains on the surface of the recording medium 1300, so an ink dot may be formed as if a bank of the dispersible colorant were formed at an outer edge portion (FIG. 7B). Subsequently, the dispersible colorant agglomerates to form a dot 1305 for forming an image at the good medium-rich center portion 1303 owing to the evaporation or penetration of a water-soluble organic solvent at the center portion (FIGS. 7C and 7D). An image to be formed through such process as described above has a sufficiently large area factor even when an amount of ink droplet is small, and has a high printing density. Moreover, the image is of high quality because the occurrence of feathering is sufficiently alleviated.

In this mechanism, the dispersible colorant has high dispersion stability because the material has a high specific surface area and a relatively low acid value in the aqueous ink. Once the dispersible colorant impinges on a recording medium and the concentration gradient of a bad medium appears at the outer periphery portion of an ink dot, the dispersible colorant is suddenly destabilized and agglomerates owing to its high specific surface area and low acid value. At this time, even when an arbitrary water-insoluble colorant having a constitution similar to that of the dispersible colorant is used instead of the dispersible colorant, an increasing effect on printing quality or a printing density can be obtained with the aid of the above mechanism. However, when a pigment dispersed into an anionic or nonionic dispersion resin which is substantially water-soluble is used as a water-insoluble colorant, the rates of destabilization and agglomeration with respect to the concentration gradient of a bad medium on a recording medium are lower than those in the case where the dispersible colorant is used. In this case, when an amount of the bad medium in the ink is increased in order to increase the rate of agglomeration of the colorant, the long-term storage stability of the ink cannot be sufficiently secured. Similarly, in the case where a pigment evenly coated with an anionic resin is used as a water-insoluble colorant, when enough anionic property to provide the ink with long-term storage stability is imparted, a balance between the rate of agglomeration on a recording medium and the rate of penetration of the colorant into the recording medium is hardly achieved. In contrast, the inventors of the present invention have found that the use of the dispersible colorant of the present invention provides a high-quality printed matter with alleviated feathering and an improved printing density, and enables the abrasion resistance, marker resistance, and water resistance of the dispersible colorant to be effectively exerted.

Under such assumed mechanism as described above, the good medium and the bad medium to be used in the present invention are determined on the basis of whether any one of them can favorably maintain the state of dispersion of the dispersible colorant. That is, the good and bad media are determined on the basis of their relationships with the dispersible colorant. Therefore, when a good medium and a bad medium are selected for the preparation of the ink according to the present invention, it is preferable that the degree of dispersion stability of a dispersible colorant to be used be observed and the solvents be determined on the basis of the observation. The inventors of the present invention have examined the criteria for judgement as to whether a solvent is a good medium or a bad medium, the good and bad media providing an effect of the present invention, in various ways in relation to the effect of the present invention. As a result, the inventors have found that the following method is preferable. That is, at first, an aqueous dispersion which contains about 50 mass % of a solvent to be judged and has a dispersible colorant to be used for the ink dispersed thereinto is stored at 60° C. for 48 hours to measure the dispersion particle size (A) in the dispersion. Next, the particle size (B) of an aqueous dispersion which contains none, or a trace amount, of the solvent to be judged and has the dispersible colorant to be used for the ink dispersed thereinto is measured. Then, in designing ink, when the dispersion particle size (A) in the dispersion is larger than the particle size (B) of the aqueous dispersion, the solvent to be judged is judged to be a bad medium, while, when the dispersion particle size (A) in the dispersion is equal to or smaller than the particle size (B) of the aqueous dispersion, the solvent to be judged is judged to be a good medium. The inventors have found that, when those water-soluble organic solvents judged on the basis of the properties with respect to the colorant are separately used, consistency with the effect of the present invention is extremely good.

To be specific, the following two dispersible colorant dispersions A and B were prepared.

A: An aqueous dispersion containing a water-soluble organic solvent to be judged at a concentration of 50 mass %, a dispersible colorant at a concentration of 5 mass %, and water at a concentration of 45 mass %; and

B: A water dispersion containing a dispersible colorant at a concentration of 5 mass % and no water-soluble organic solvent.

After having been stored at 60° C. for 48 hours, the dispersion A was cooled to room temperature, and the dispersion particle size at this time was measured by means of, for example, a concentrated particle size analyzer (trade name: FPAR-1000; manufactured by Otsuka Electronics Co., Ltd.). The particle size of the water dispersion B was also measured by means of the concentrated particle size analyzer. The values of the particle sizes of the dispersion A and the water dispersion B were denoted by a particle size (A) and a particle size (B), respectively. A good medium and a bad medium were judged by means of those values in accordance with the following definition. An ink having the constitution of the present invention was prepared by means of the judged good and bad media. Thus, it was confirmed that such excellent effect as described above can be obtained. When the particle size (A) was larger than the particle size (B), the water-soluble organic solvent to be judged was defined as a bad medium, while, when the particle size (A) was equal to or smaller than the particle size (B), the water-soluble organic solvent to be judged was defined as a good medium.

The aqueous ink of the present invention may have a constitution similar to that of aqueous ink containing the conventional water-insoluble colorant except that: the aqueous ink of the present invention contains a dispersible colorant having the above-described specific shape as a colorant; and a water-soluble organic solvent has the above-described specific constitution. That is, a first feature of the aqueous ink of the present invention lies in that: the aqueous ink is composed of at least water, multiple water-soluble organic solvents, and a dispersible colorant; the dispersible colorant is a dispersible colorant containing a colorant and chargeable resin pseudo fine particles each of which is smaller than the colorant; and the colorant and the chargeable resin pseudo fine particles fix to each other.

A third feature of the present invention lies in that: the ink contains, as water-soluble organic solvents, at least one kind of water-soluble organic solvent judged to be a good medium according to such judgment method as described above and at least one kind of water-soluble organic solvent judged to be a bad medium; and when a total amount of the good medium in the ink (mass %) is denoted by A and a total amount of the bad medium in the ink (mass %) is denoted by B, a ratio A:B [the total amount of the good medium in the ink (mass %):the total amount of the bad medium in the ink (mass %)] is adjusted to fall within the range of 10:5 to 10:30.

A fourth feature of the aqueous ink of the present invention lies in that a water-soluble organic solvent showing the maximum Ka value out of respective Ka values of multiple water-soluble organic solvents each determined by a Bristow method is the bad medium. As a result, the dispersion stability of the dispersible colorant in the ink becomes extremely excellent. At the same time, when a letter is printed by means of the ink on a recording medium, especially on plain paper, an image extremely excellent in image quality can be formed, which has a sufficiently large area factor even when an amount of ink droplet is small, and has a high printing density.

Here, a Ka value determined by a Bristow method will be described. The value is used as an indication for the penetrability of ink into a recording medium. That is, when the penetrability of ink is represented by the amount V of the ink per 1 m², the amount of penetration V of the ink into a recording medium (mL/m²=μm) after a predetermined time t from the eject of an ink droplet is represented by Bristow's equation shown below.
V=Vr+Ka(t−tw)^{1/2}

Here, immediately after an ink droplet has fixed to the surface of a recording medium, most of the ink is absorbed by irregularities on the surface of the recording medium (rough portions on the surface of the recording medium), and nearly no ink penetrates into the recording medium. The time required for the absorption is a contact time (tw), and the amount of the ink absorbed by the irregularities of the recording medium during the contact time is denoted by Vr. Then, after the ink has fixed, the amount of penetration increases by an amount in proportion to the square root of the time exceeding the contact time, that is, (t−tw). Ka represents a proportionality factor of the increase, and shows a value in accordance with the rate of penetration. The Ka value can be measured by means of, for example, a dynamic penetrability testing device for a liquid according to a Bristow method (for example, trade name: dynamic penetrability testing device S; manufactured by Toyo Seiki Seisaku-Sho, Ltd.).

The aqueous ink according to the present invention is characterized in that a water-soluble organic solvent showing the maximum Ka value out of respective Ka values of the multiple water-soluble organic solvents in the aqueous ink each determined by a Bristow method is the bad medium. According to the investigation by the inventors of the present invention, for additionally improving the quality of a recorded image to be formed, each of the Ka values in the ink is adjusted to be preferably less than 1.5, or more preferably 0.2 or more and less than 1.5. That is, when each of the Ka values in the ink is adjusted to be less than 1.5, solid-liquid separation occurs at an early stage of the course of the penetration of the ink into a recording medium, so a high-quality image with significantly alleviated feathering can be formed.

The Ka value according to the Bristow method in the present invention is a value measured by means of plain paper [for example, PB paper to be used for a copying machine utilizing an electrophotographic method manufactured by CANON Inc., a page printer (laser beam printer), or a printer utilizing an ink jet recording method, or PPC paper for a copying machine utilizing an electrophotographic method] as a recording medium. The assumed measurement environment is an ordinary office environment such as an environment having a temperature of 20 to 25° C. and a humidity of 40 to 60%.

If an image in which black and color inks are mixed is formed on plain paper and the aqueous ink according to the present invention is used as the black ink, as described above, the agglomeration or dispersion breakage of the colorant constituting the black ink on the paper is expected to proceed faster than that of any other ink. In the ink jet recording method as an image forming method in the present invention, the aqueous ink of the present invention is used as black ink. In addition, image formation by a color ink is performed after image formation by the black ink, or preferably, scanning for applying a coloring ink is performed at least one scan after scanning for applying the black ink. As a result, no bleeding between black and color inks occurs even when the black is in contact with the color ink, so an image excellent in bleed resistance can be formed. That is, the image formation by the black ink and the image formation by each color ink are performed at different times. As a result, such excellent effect as described above can be obtained without any need for a method involving performing multi-path printing which completes printing through multiple scans and requires a printing time or for a method in which recovery systems are separately prepared for black and colors inks, so an increase in size of equipment inevitably occurs.

In addition, when the aqueous ink of the present invention is used, the colorant in the ink efficiently remains on a recording medium owing to the reason described above. Therefore, a letter can be printed at a high concentration with an amount of ink smaller than the eject amount (droplet volume) of the conventional ink. Effects such as a reduction in cost for image formation and a shorter fixation time than that of the conventional ink can also be expected from the fact that a letter can be printed with a small amount of ink.

The respective components constituting the ink of the present invention will be described below. First, an aqueous medium into which the dispersible colorant is to be dispersed will be described.

[Aqueous Medium]

The aqueous ink of the present invention contains a mixed solvent of water and water-soluble organic solvents. The water-soluble organic solvents can be selected from those listed below. In the present invention, water-soluble organic solvents must be selected and appropriately blended to prepare ink in such a manner that: in selecting the water-soluble organic solvents, each water-soluble organic solvent is judged to be a good or bad medium with respect to a dispersible colorant to be used by means of the method described above; and, on the basis of the results of judgment, at least both the good and bad media are present and the content of each water-soluble organic solvent is in the range specified in the present invention.

Specific examples of the water-soluble organic solvents include: alkyl alcohols each having 1 to 4 carbon atoms such as methyl alcohol, ethyl alcohol, n-propyl alcohol, isopropyl alcohol, n-butyl alcohol, sec-butyl alcohol, and tert-butyl alcohol; amides such as dimethylformamide and dimethylacetamide; ketones or keto alcohols such as acetone and diacetone alcohol; ethers such as tetrahydrofuran and dioxane; polyalkylene glycols such as polyethylene glycol and polypropylene glycol; alkylene glycols in each of which an alkylene group has 2 to 6 carbon atoms such as ethylene glycol, propylene glycol, butylene glycol, triethylene glycol, 1,2,6-hexane triol, thio diglycol, hexylene glycol, and diethylene glycol; lower alkyl ether acetates such as polyethylene glycol monomethyl ether acetate; glycerin; lower alkyl ethers of polyhydric alcohols such as ethylene glycol monomethyl (or ethyl) ether, diethylene, glycol methyl (or ethyl) ether, and triethylene glycol monomethyl (or ethyl) ether; N-methyl-2-pyrrolidone; 2-pyrrolidone; and 1,3-dimethyl-2-imidazolidinone. In addition, deionized water is desirably used as water.

The water-soluble organic solvent content in the aqueous ink of the present invention, which is not particularly limited, is preferably in the range of 3 to 50 mass % with respect to the total mass of the ink. The water content in the ink is preferably in the range of 50 to 95 mass % with respect to the total mass of the ink.

A feature of the present invention lies in that the kinds and contents of the water-soluble organic solvents constituting the aqueous ink are adjusted in such a manner that, when a total amount of the good medium in the ink (mass %) is denoted by A and a total amount of the bad medium in the ink (mass %) is denoted by B, a ratio A:B is in the range of 10:5 to 10:30, preferably 10:5 to 10:10, or more preferably 10:6 to 10:10. According to detailed investigation by the inventors of the present invention, when the ratio of the good medium in the aqueous ink is large, excellent storage stability can be obtained, but a high printing density is hardly obtained, while, when the ratio of the good medium in the aqueous ink is small, a high printing density can be obtained, but storage stability may be insufficient. Compatibility between the storage stability of the ink and the realization of a high printing density can be achieved by controlling a ratio between the good medium and the bad medium in the water-soluble organic solvents in the ink as described above. Furthermore, as described above, in the present invention, an effect that cannot have been conventionally obtained can be achieved, in which even with a small amount of ink droplet, a sufficiently large area factor and a high printing density can be realized by controlling a Ka value determined by the Bristow method, which is an indication for the penetrability of each water-soluble organic solvent to be incorporated into the ink into a recording medium in determining each water-soluble organic solvent to be incorporated into the ink.

(Aqueous Ink)

The aqueous ink according to the present invention is characterized by containing the dispersible colorant described above and a specific water-soluble organic solvent. When a dispersible colorant to be used is a pigment, the pigment content is 0.1 mass % or more and 20 mass % or less, or preferably 0.3 mass % or more and 15 mass % or less with respect to the ink. Water or a mixed medium containing water and a water-soluble organic solvent as required is also a preferable aqueous medium. The aqueous ink may contain a penetrating agent that helps the ink penetrate into a recording medium, an antiseptic, an antifungus agent, or the like.

As shown in FIGS. 1A and 1B, the dispersible colorant to be used in the present invention is present in the ink in a state where the chargeable resin pseudo fine particles 2 fix to the surface of the colorant 1. Therefore, the colorant fixes to a recording medium and an adjacent colorant on the recording medium via the chargeable resin pseudo fine particles adhering to the surface. Accordingly, a printed matter obtained by using the aqueous ink of the present invention has excellent abrasion resistance.

Furthermore, when a pigment is used as the colorant, a ratio of chargeable resin pseudo fine particles to a pigment (represented by resin mass/pigment mass=B/P) is desirably set in the range of 0.3 to 4.0 (both inclusive) in the present invention for enhancing the abrasion resistance of a printed matter to be formed by means of the colorant. Setting the B/P ratio equal to or larger than 0.3 enhances adhesiveness between colorants and adhesiveness between a colorant and a recording medium, to thereby provide a printed matter with excellent abrasion resistance. In particular, film formability of aqueous ink using a dispersible colorant obtained by allowing chargeable resin pseudo fine particles composed of copolymer components each having a glass transition temperature of −40° C. or higher and 60° C. or lower to fix to a colorant can be expressed with improved effectiveness, whereby abrasion resistance in glossy paper can be enhanced. When the B/P ratio is much larger than 4.0, the ink entirely has high viscosity, and eject stability may be impaired when the ink is used for an ink jet recording apparatus. In addition, color developability of the colorant on a recording medium is inhibited and a sufficient printing density is not obtained in some cases because the resin amount is extremely large as compared to the colorant. Setting the value of the B/P ratio in the range of 0.3 to 4.0 (both inclusive) provides aqueous ink that has achieved compatibility between excellent abrasion resistance and eject stability in an ink jet recording apparatus.

The term “resin mass” as used herein refers to the total amount of the chargeable resin pseudo fine particles in the ink according to the present invention, and the total amount also includes the amount of resin components apparently and strongly adsorbed to a pigment surface in some cases; provided, however, that the total amount does not include the amount of water-soluble resin components that can be easily separated from a pigment.

The value of the B/P ratio described above, which can generally be determined by means of differential thermogravimetric analysis, is measured and calculated by means of a TGA/SDTA851 manufactured by METTLER-TOLEDO International Inc. That is, in the present invention, the dispersible colorant according to the present or aqueous ink for ink jet recording containing the colorant was centrifuged at 80,000 rpm for 2 hours. The precipitate was dried and weighed, and its temperature was increased in a nitrogen atmosphere or in the air. A change in mass before and after the decomposition temperature of each of the pigment and the resin components at the time of temperature increases was determined to calculate the B/P ratio.

(Recorded Image)

The ink according to the present invention can be suitably used for recording using an ink jet recording apparatus to be described later. A recording medium to be used at this time is not limited, and may be, for example, a medium that enables ink jet recording.

(Image Forming Method)

The ink jet recording method according to the present invention is characterized by including forming an image in an ink jet recording apparatus by means of the aqueous ink of the present invention. For example, the ink jet recording method is preferably an ink jet recording method including performing recording on plain paper by means of black ink and aqueous color ink of at least one color, in which: the aqueous ink having the above-described constitution is used as the black ink; and, when an image in which an image formed by the black ink and an image formed by the color ink are adjacent to each other is to be formed, scanning for applying the black ink is performed to form an image before scanning for applying the color ink to a region where the image is formed is performed.

Here, the color ink that can be suitably used in the present invention will be described. Any conventionally known aqueous color ink for ink jet recording can be used for the image forming method of the present invention. An example of a colorant for the color ink includes a water-soluble dye, and a water-soluble dye having an anionic group as a solubilizing group is particularly preferably used. The color of the color ink to be used in the present invention can be appropriately selected from, for example, cyan, magenta, yellow, red, green, blue, and orange.

The water-soluble dye having an anionic group to be used in the present invention is not particularly limited as long as it is a water-soluble acid dye, direct dye, or reactive dye described in COLOUR INDEX. Any dye which has an anionic group such as a sulfonic group but is not described in COLOUR INDEX may also be used without any particular limitation. The dye content in the ink is 1 to 10 mass %, or preferably 1 to 5 mass %.

Specific examples of the dye are shown below.

C.I. Direct Yellow: 8, 11, 12, 27, 28, 33, 39, 44, 50, 58, 85, 86, 87, 88, 98, 100, 110

C.I. Direct Red: 2, 4, 9, 11, 20, 23, 24, 31, 39, 46, 62, 75, 79, 80, 83, 89, 95, 197, 201, 218, 220, 224, 225, 226, 227, 228, 230

C.I. Direct Blue: 1, 15, 22, 25, 41, 76, 77, 80, 86, 90, 98, 106, 108, 120, 158, 163, 168, 199, 226

C.I. Acid Yellow: 1, 3, 7, 11, 17, 23, 25, 29, 36, 38, 40, 42, 44, 76, 98, 99

C.I. Acid Red: 6, 8, 9, 13, 14, 18, 26, 27, 32, 35, 42, 51, 52, 80, 83, 87, 89, 92, 94, 106, 114, 115, 133, 134, 145, 158, 198, 249, 265, 289

C.I. Acid Blue: 1, 7, 9, 15, 22, 23, 25, 29, 40, 43, 59, 62, 74, 78, 80, 90, 100, 102, 104, 117, 127, 138, 158, 161

In addition to the foregoing, the following items 1. to 3. can be given as examples of a colorant for the color ink that can be used in the present invention. Each of those colorants is preferable because it exerts excellent water resistance when applied to a recording medium.

1. A dye having a carboxyl group as a solubilizing group

2. An oil-soluble dye

3. A pigment

The oil-soluble dye is not particularly limited as long as it is described in COLOUR INDEX. A novel dye not described in COLOUR INDEX may also be used without any particular limitation. Specific examples thereof include the following. The dye content in the ink is preferably 1 to 10 mass %, or more preferably 1 to 5 mass %.

C.I. Solvent Blue: 33, 38, 42, 45, 53, 65, 67, 70, 104, 114, 115, 135

C.I. Solvent Red: 25, 31, 86, 92, 97, 118, 132, 160, 186, 187, 219

C.I. Solvent Yellow: 1, 49, 62, 74, 79, 82, 83, 89, 90, 120, 121, 151, 153, 154

When a pigment is used as the colorant for the color ink to be used in the present invention, the pigment is used in an amount of 1 to 20 mass %, or preferably 2 to 12 mass % in mass ratio with respect to the total mass of the ink. Examples of a color organic pigment that can be used in the present invention include the following.

Examples of a pigment to be used for yellow ink include C.I. Pigment Yellow 1, C.I. Pigment Yellow 2, C.I. Pigment Yellow 3, C.I. Pigment Yellow 13, C.I. Pigment Yellow 16, C.I. Pigment Yellow 74, C.I. Pigment Yellow 83, and C.I. Pigment Yellow 128.

Examples of a pigment to be used for magenta ink include C.I. Pigment Red 5, C.I. Pigment Red 7, C.I. Pigment Red 12, C.I. Pigment Red 48(Ca), C.I. Pigment Red 48(Mn), C.I. Pigment Red 57(Ca), C.I. Pigment Red 112, and C.I. Pigment Red 122.

Examples of a pigment to be used for cyan ink include C.I. Pigment Blue 1, C.I. Pigment Blue 2, C.I. Pigment Blue 3, C.I. Pigment Blue 15:3, C.I. Pigment Blue 16, C.I. Pigment Blue 22, C.I. Vat Blue 4, and C.I. Vat Blue 6. However, the present invention is not limited to them. In addition to the foregoing, a pigment newly produced for the present invention may also surely be used.

When a pigment is used, a dispersant for dispersing the pigment into ink, which is not limited as long as it is a water-soluble resin, is one having a weight average molecular weight in the range of preferably 1,000 to 30,000, or more preferably 3,000 to 15,000. Specific examples of such dispersant include: block copolymers, random copolymers, and graft copolymers each composed of at least two monomers (at least one of which is a hydrophilic monomer) selected from styrene, a styrene derivative, vinyl naphthalene, a vinyl naphthalene derivative, a fatty acid alcohol ester of α,β-ethylenically unsaturated carboxylic acid, acrylic acid, an acrylic acid derivative, maleic acid, a maleic acid derivative, itaconic acid, an itaconic acid derivative, fumaric acid, a fumaric acid derivative, vinyl acetate, vinyl pyrrolidone, and acrylamide and a derivative thereof; and salts of the monomers. Alternatively, a natural resin such as rosin, shellac, or starch is also preferably used. Those resins are soluble in aqueous solutions into which bases are dissolved, and are alkali-soluble resins. The content of water-soluble resins to be used as those pigment dispersants is preferably in the range of 0.1 to 5 mass % with respect to the total mass of the ink.

A suitable aqueous liquid medium in the color ink to be used in the present invention is water or a mixed solvent of water and a water-soluble organic solvent, and water is preferably ion-exchanged water (deionized water) rather than general water containing various ions. Examples of the water-soluble organic solvent to be mixed with water include: alkyl alcohols each having 1 to 4 carbon atoms such as methyl alcohol, ethyl alcohol, n-propyl alcohol, isopropyl alcohol, n-butyl alcohol, sec-butyl alcohol, and tert-butyl alcohol; amides such as dimethylformamide and dimethylacetamide; ketones or keto alcohols such as acetone and diacetone alcohol; ethers such as tetrahydrofuran and dioxane; polyalkylene glycols such as polyethylene glycol and polypropylene glycol; alkylene glycols in each of which an alkylene group has 2 to 6 carbon atoms such as ethylene glycol, propylene glycol, butylene glycol, triethylene glycol, 1,2,6-hexane triol, thio diglycol, hexylene glycol, and diethylene glycol; glycerin; lower alkyl ethers of polyhydric alcohols such as ethylene glycol monomethyl (or ethyl) ether, diethylene glycol methyl (or ethyl) ether, and triethylene glycol monomethyl (or ethyl) ether; N-methyl-2-pyrrolidone; 2-pyrrolidone; and 1,3-dimethyl-2-imidazolidinone. Of those many water-soluble organic solvents, a polyhydric alcohol such as diethylene glycol or a lower alkyl ether of a polyhydric alcohol such as triethylene glycol monomethyl (or ethyl) ether is preferable.

The content of such water-soluble organic solvent as described above in the color ink is generally in the range of 3 to 50 mass %, or preferably in the range of 3 to 40 mass % with respect to the total mass of the ink. The content of water to be used is in the range of 10 to 90 mass %, or preferably 30 to 80 mass % with respect to the total mass of the ink. In addition, the color ink to be used in the present invention can be appropriately added with a surfactant, a defoaming agent, an antiseptic, or the like as well as the above components to provide ink having desired physical property values as required.

The black and color inks to be used in the present invention composed of such components as described above each preferably have property with which the ink can be favorably ejected from an ink jet recording head. To this end, the inks each preferably have properties including a viscosity of 1 to 15 mPa·s (more preferably 1 to 5 mPa·s) and a surface tension of 25 mN/m or more (more preferably 25 to 50 mN/m) from the viewpoint of eject property from an ink jet recording head. When a black ink and a color ink are used in combination, the surface tension of the black ink is particularly preferably higher than that of the color ink. To be specific, the black ink has a surface tension of 35 to 50 mN/m, while the color ink has a surface tension of 25 to 35 mN/m.

(Image Recording Method and Recording Apparatus)

The dispersible colorant to be used in the present invention, and aqueous ink containing the colorant are each used for a head according to an ink jet ejecting method, and are effective for an ink tank storing the ink or ink for filling the tank. In particular, the present invention has an excellent effect on a recording head or recording apparatus according to a bubble jet method out of the ink jet recording methods.

The representative structure and principle of a bubble jet method are preferably basic principles disclosed in, for example, U.S. Pat. No. 4,723,129 and U.S. Pat. No. 4,740,796. The method is applicable to any one of so-called an on-demand type and a continuous type. In particular, the method is effective for the on-demand type because of the following reason. At least one driving signal which corresponds to recording information and causes a sudden increase in temperature exceeding nuclear boiling is applied to an electrothermal converter arranged in correspondence with a sheet or liquid path holding ink, to thereby cause the electrothermal converter to generate thermal energy. Then, a thermal action surface of a recording head is caused to generate film boiling. As a result, an air bubble in the ink can be formed so as to be in one-to-one correspondence with the driving signal. The growth and contraction of the air bubble cause the ink to be ejected through an opening for eject, thereby forming at least one droplet. The driving signal is more preferably of a pulse shape because the growth and contraction of an air bubble can be performed immediately and appropriately, and hence ink can be ejected with excellent responsiveness. Such signals as described in U.S. Pat. No. 4,463,359 and U.S. Pat. No. 4,345,262 are suitable as pulse-shaped driving signals. It should be noted that additionally excellent recording can be performed by adopting the conditions described in U.S. Pat. No. 4,313,124, which is an invention relating to a rate of temperature increase of the thermal action surface.

With regard to the constitution of a recording head, the present invention is effective for any one of the structures disclosed in U.S. Pat. No. 4,558,333 and U.S. Pat. No. 4,459,600 in each of which a thermal action portion is arranged in a bending region as well as such constitution obtained by combining a eject port, a liquid path, and an electrothermal converter (a linear liquid flow path or a right angle liquid flow path) as disclosed in each of the above specifications. The present invention is also effective for the constitution in which a eject port common to multiple electrothermal converters is used as the eject portion of the electrothermal converters (Japanese Patent Application Laid-Open No. S59-123670 or the like). Furthermore, a full-line type recording head having a length in correspondence with the width of the largest recording medium that a recording apparatus can perform recording on may have a constitution satisfying the length or a constitution as a single recording head obtained by integrally forming recording heads depending on the combination of such multiple recording heads as disclosed in the above specifications. The present invention can exert the above-described effect with improved effectiveness.

The present invention is also effective for a freely exchangeable chip-type recording head that is mounted on an apparatus main body to enable electrical connection with the apparatus main body and the supply of ink from the apparatus main body, or for a cartridge-type recording head that is integrally mounted on a recording head itself. Adding recovery means, preliminary auxiliary means, or the like to a recording head to be arranged as one component of a recording apparatus to which the present invention is applicable is preferable because the effect of the present invention can be additionally stabilized. Specific examples of such means include: capping means, cleaning means, and pressuring or sucking means to a recording head; an electrothermal converter or a heating element separate from the converter, or preliminary heating means obtained by combining the converter and the element; and a preliminary eject mode for performing eject separate from recording.

An example of an image forming method to be preferably used for the present invention includes an ink jet image forming method involving the use of black ink and aqueous color ink of at least one color to perform recording on plain paper, which is characterized in that: the aqueous ink of the present invention having the above-described constitution is used as the black ink; and, when an image in which an image formed by the black ink and an image formed by the color ink are adjacent to each other is to be formed, scanning for applying the black ink is performed to form an image before scanning for applying the color ink to a region where the image is formed is performed.

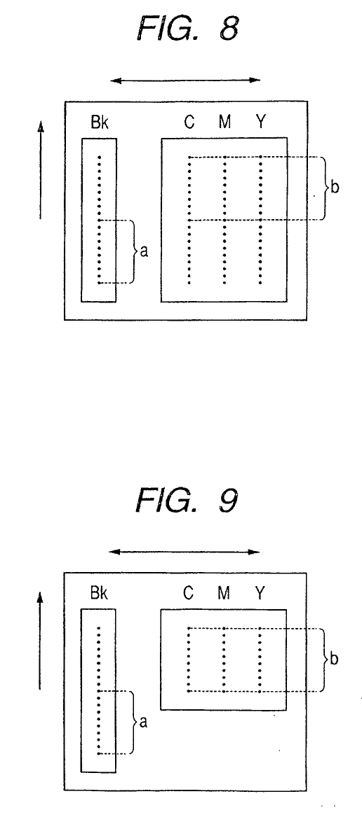

FIG. 8 shows an example of a recording head to be used for performing the image forming method of the present invention. As shown in FIG. 8, the recording head includes a eject port train (Bk) for ejecting a black ink and eject port trains for ejecting three color inks, that is, a cyan (C) ink, a magenta (M) ink, and a yellow (Y) ink. In the image forming method of the present invention, a recording head in which a eject port train for black for ejecting a black ink and a eject port train for color for ejecting a color ink are arranged so as to shift from each other in a sub scanning direction is preferably used for forming a color image. For this reason, for example, when the recording head shown in FIG. 8 is used to form an image, the entire region of the eject port train for black is preferably used for the formation of an image composed only of a black color, while, when a color image in which black and a color are present is to be formed, the part a in the figure is preferably used for black and the part b in the figure is preferably used for C, M, and Y. Hereinafter, the formation of an image in which black and a color are present will be described in more detail with reference to FIG. 8.

In FIG. 8, at first, the part a of the eject port train for black is used to scan a print head in the horizontal direction in the figure (main scanning direction), whereby image data for black is formed through one-path printing on a recording medium such as plain paper. Next, the recording medium is conveyed in the vertical direction in the figure (sub scanning direction) by a distance of a. During the process of the subsequent main scanning of the print head in an approaching direction, the part b of the eject port trains for color is used to form a color image through one-path printing in the region where the image has been formed by the a train for black. At the same time, the eject port train a for black forms an image in a subsequent region. An image in which black and a color are present is formed through the repetition of the above procedure.

FIG. 9 shows another example of a recording head that can be used for performing the image forming method of the present invention. As in the case of FIG. 8, in FIG. 9 as well, the part a in the figure is used for black and the part b in the figure corresponding to the entire region of the eject port trains is used for C, M, and Y. Then, in the same manner as that described with reference to FIG. 8, an image in which black and a color are present is formed.

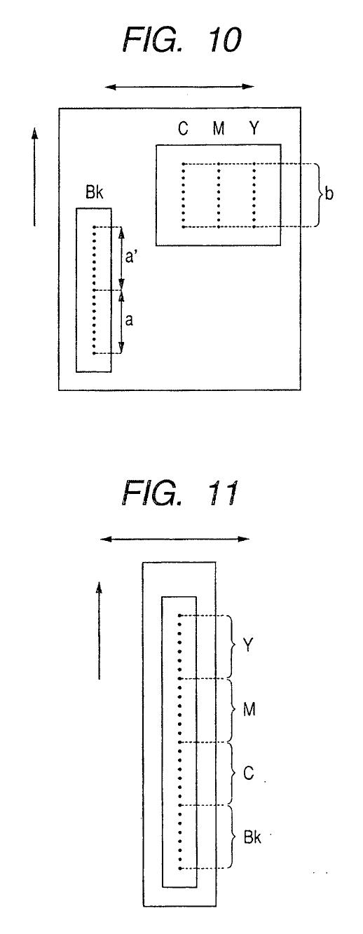

FIG. 10 shows another example of a recording head that can be used for performing the image forming method of the present invention. As in the case of FIG. 8, in FIG. 10 as well, the part a of the eject port train in the figure is used for black and the part b in the figure corresponding to the entire region of the eject port trains for color is used for C, M, and Y. Then, an image in which black and a color are present is formed. As shown in FIG. 10, in the recording head shown in the figure, the part a of the eject port train for black and the part b for color are distance from each other by an amount a for single sheet feeding. For this reason, in the recording head having such constitution, a time difference for one print scan is excessively generated by a reciprocation during the time period commencing on the formation of a black image and ending on the formation of a color image. Therefore, the constitution of the recording head shown in FIG. 10 more effectively prevents bleeding between black and a color than the constitution shown in FIG. 9.

FIG. 11 shows another example of a recording head that can be used for performing the image forming method of the present invention. Even in the case where a recording head as shown in the figure in which eject port trains for black and color are arranged in order in a single file in a sheet feeding direction is used, a color image is formed after a black image has been formed in accordance with sheet feeding.

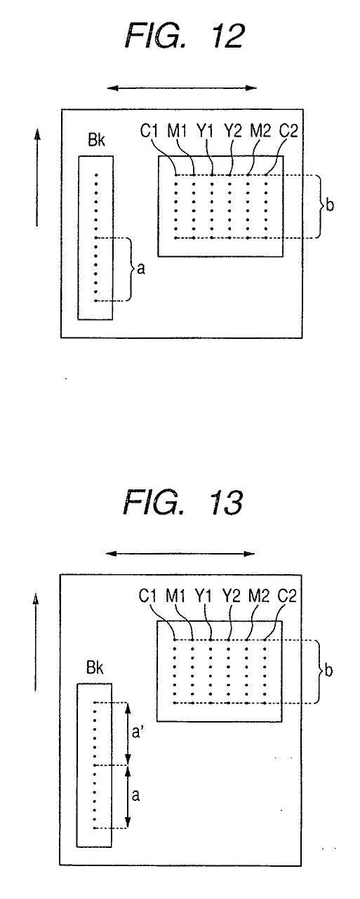

FIG. 12 shows another example of a recording head that can be used for performing the image forming method of the present invention. The recording head shown in FIG. 12 has a constitution in which two eject trains for each of cyan (C1 and C2), magenta (M1 and M2), and yellow (Y1 and Y2) are arranged so as to be symmetric with respect to each other in the main scanning direction in such a manner that the order of impingement of color ink of scanning in an approaching direction and that of scanning in a returning direction are identical to each other. As a result, bidirectional printing can be performed even in the formation of an image in which black and a color are present. In this case, at first, a black image is formed by the part a for black and then a recording medium is conveyed by a distance of a. During the process of the subsequent main scanning of a print head in the approaching direction, the part b of the eject port trains for color is used to form a color image through one-path printing in the region where the image has been formed by the a train for black.

Of course, in the same manner as that described above, even in the head corresponding to bidirectional printing as shown in FIG. 12, black and color nozzles may be arranged in such a manner that there is an interval of one scan between the formation of a black image and the formation of a color image, to thereby more effectively prevent bleeding (see FIG. 13). Although the image forming method of the present invention has been described above, the form of a recording head that can be used for the method of the present invention is not limited to any one of FIGS. 8 to 13.

### EXAMPLES

Next, the present invention will be described specifically by way of examples and comparative examples. However, the present invention is not limited to the following examples within the gist thereof. The terms “part(s)” and “%” in the following description refer to “part(s) by mass” and “mass %”, respectively unless otherwise stated.

(Preparation of Pigment Dispersion 1)

First, a mixed liquid composed of 10 parts of carbon black, 6 parts of glycerin, 10 parts of a styrene-acrylic acid-based resin dispersant, and 74 parts of water was dispersed by means of a sand mill manufactured by KANEDA SCIENTIFIC CO., LTD. at 1,500 rpm for 5 hours to prepare a pigment dispersion 1. Zirconia beads each having a diameter of 0.6 mm were used in the sand mill, and accounted for 70% of the pot. The carbon black used in this example was Black Pearls 880 (hereinafter, abbreviated as BP880) available from Cabot Corporation in the United States, and the styrene-acrylic acid-based resin dispersant had a copolymerization ratio of 70:30, an Mw of 8,000, and an acid value of 170. Such styrene-acrylic acid-based resin dispersant was prepared by: adding water and potassium hydroxide having the above acid value and equivalent in advance; and stirring the mixture at 80° C. to prepare an aqueous solution. The resultant pigment dispersion 1 had an average dispersion particle size of 98 nm, which means that the particles were stably dispersed, and had a polydispersity index of 0.16.

(Production of Dispersible Colorant 1)

Next, while 100 parts of the pigment dispersion 1 thus obtained were heated to 70° C. under a nitrogen atmosphere and stirred by means of a motor, the following three liquids were filled in a titration apparatus and added dropwise to perform polymerization for 5 hours: (1) 5.5 parts of methyl methacrylate, (2) 0.5 part of acrylic acid, 0.12 part of potassium hydroxide, and 20 parts of water, and (3) 0.05 part of potassium persulfate and 20 parts of water. The resultant dispersion was diluted with water by 10-fold, and centrifuged at 5,000 rpm for 10 minutes to remove an agglomerated component. After that, the remainder was additionally centrifuged at 12,500 rpm for 2 hours to be purified, thereby resulting in a dispersible colorant 1 as a precipitate. The dispersible colorant 1 was dispersed into water, and the dispersion was centrifuged at 12,000 rpm for 60 minutes to re-disperse the precipitate into water. The resultant was dried and observed with a scanning electron microscope JSM-6700 (manufactured by JEOL DATUM) at a magnification of 50,000. As a result, the dispersible colorant 1 was observed to have chargeable resin pseudo fine particles each of which was smaller than the colorant adhering to the surface of the carbon black. The shape of any subsequent colorant described in this example was observed in the same manner as that described above.

(Production of Dispersible Colorant 2)

While 100 parts of the pigment dispersion 1 were heated to 70° C. under a nitrogen atmosphere and stirred by means of a motor, the following three liquids were filled in a titration apparatus and added dropwise to perform polymerization for 5 hours: (1) 5.5 parts of methyl methacrylate, (2) 0.3 part of acrylic acid, 0.12 part of potassium hydroxide, and 20 parts of water, and (3) 0.05 part of potassium persulfate and 20 parts of water. The resultant dispersion was diluted with water by 10-fold, and centrifuged at 5,000 rpm for 10 minutes to remove an agglomerated component. After that, the remainder was additionally centrifuged at 12,500 rpm for 2 hours to be purified, thereby resulting in a dispersible colorant 2 as a precipitate.

(Preparation of Pigment Dispersion 2)

10 parts of BP 880 and 3.41 parts of p-amino-N-benzoic acid were sufficiently mixed with 72 parts of water. Then, 1.62 parts of nitric acid were added dropwise to the mixture, and the whole was stirred at 70° C. Several minutes after that, a solution prepared by dissolving 1.07 parts of sodium nitrite into 5 parts of water was added to the resultant, and the whole was stirred for an additional 1 hour. The resultant slurry was filtered through a Toyo Roshi No. 2 (manufactured by ADVANTEC). Pigment particles were sufficiently washed with water, and dried by means of an oven at 90° C. After that, water was added to the pigment to prepare a pigment aqueous solution having a pigment concentration of 10 mass %. According to the above method, a pigment dispersion 2 was obtained, which had dispersed thereinto self-dispersible carbon black having a hydrophilic group on its surface via a phenyl group and charged to be anionic.

(Production of Dispersible Colorant 3)

While 100 parts of the pigment dispersion 2 thus obtained and 2 parts of a styrene-acrylic acid-based resin dispersant (having a copolymerization ratio of 70:30, an Mw of 8,000, and an acid value of 170) were heated to 70° C. under a nitrogen atmosphere and stirred by means of a motor, the following three liquids were filled in a titration apparatus and added dropwise to perform polymerization for 5 hours: (1) 5.7 parts of methyl methacrylate, (2) 0.9 part of sodium p-styrenesulfonate and 20 parts of water, and (3) 0.05 part of potassium persulfate and 20 parts of water. The resultant dispersion was diluted with water by 10-fold, and centrifuged at 5,000 rpm for 10 minutes to remove an agglomerated component. After that, the remainder was additionally centrifuged at 12,500 rpm for 2 hours to be purified, thereby resulting in a dispersible colorant 3 as a precipitate.

(Production of Dispersible Colorant 4)

While 100 parts of the pigment dispersion 1 were heated to 70° C. under a nitrogen atmosphere and stirred by means of a motor, the following three liquids were filled in a titration apparatus and added dropwise to perform polymerization for 5 hours as described above: (1) 12.84 parts of methyl methacrylate and 4.26 parts of methoxy polyethylene glycol methacrylate (manufactured by Shin-Nakamura Chemical Co., Ltd.: NK Ester M90G), (2) 0.9 part of acrylic acid, 0.35 part of potassium hydroxide, and 20 parts of water, and (3) 0.05 part of potassium persulfate and 20 parts of water. After that, the resultant dispersion was diluted with water by 10-fold, and centrifuged at 5,000 rpm for 10 minutes to remove an agglomerated component. After that, the remainder was additionally centrifuged at 12,500 rpm for 2 hours, to thereby result in a dispersible colorant 4 as a precipitate.

(Preparation of Pigment Dispersion 3)

Wet carbon oxide manufactured by Tokai Carbon Co., Ltd. was used as a carbon black dispersing element into which a hydrophilic group was directly introduced. The wet carbon oxide used in this example was obtained by oxidizing the surface of carbon black in an aqueous phase by means of an oxidant. As in the case of Example 3, the surface oxygen amount of the wet carbon oxide was measured. The carbon showed a heating loss of 15 mass %.

(Production of Dispersible Colorant 5)

While 100 parts of the pigment dispersion 2 and 2 parts of a styrene-acrylic acid-based resin dispersant (having a copolymerization ratio of 70:30, an Mw of 8,000, and an acid value of 170) were heated to 70° C. under a nitrogen atmosphere and stirred by means of a motor, the following three liquids were filled in a titration apparatus and gradually added dropwise to perform polymerization for 5 hours as described above: (1) 12.84 parts of methyl methacrylate and 4.26 parts of methoxy polyethylene glycol methacrylate (manufactured by Shin-Nakamura Chemical Co., Ltd.: NK Ester M90G), (2) 0.9 part of acrylic acid, 0.35 part of potassium hydroxide, and 20 parts of water, and (3) 0.05 part of potassium persulfate and 20 parts of water. After that, the resultant dispersion was diluted with water by 10-fold, and centrifuged at 5,000 rpm for 10 minutes to remove an agglomerated component. After that, the remainder was additionally centrifuged at 12,500 rpm for 2 hours, to thereby result in a dispersible colorant 5 as a precipitate.

(Production of Dispersible Colorant 6)

While 100 parts of the pigment dispersion 3 thus obtained were heated to 70° C. under a nitrogen atmosphere and stirred by means of a motor, the following three liquids were filled in a titration apparatus and added dropwise to perform polymerization for 5 hours: (1) 5.5 parts of methyl methacrylate, (2) 0.5 part of acrylic acid, 0.12 part of potassium hydroxide, and 20 parts of water, and (3) 0.05 part of potassium persulfate and 20 parts of water. The resultant dispersion was diluted with water by 10-fold, and centrifuged at 5,000 rpm for 10 minutes to remove an agglomerated component. After that, the remainder was additionally centrifuged at 12,500 rpm for 2 hours to be purified, thereby resulting in a dispersible colorant 6 as a precipitate.

[Properties of Dispersible Colorants]

The dispersible colorants 1 to 6 were observed and their physical properties were measured in the manners described below. Table 1 shows the results.

<Fixation/Interspersion Properties of Resin Fine Particles>

Each of the dispersible colorants was dispersed into water and dried. The resultant was observed with a scanning electron microscope JSM-6700 (manufactured by JEOL DATUM) at a magnification of 50,000. The states of fixation of resin fine particles to the colorant and the properties of the adhering resin fine particles were evaluated as follows.

(States of Fixation of Resin Fine Particles)

∘: The fixation of resin fine particles was observed.

x: The fixation of resin fine particles could not be observed.

(Interspersion Properties of Resin Fine Particles)

∘: The interspersion of resin fine particles was observed.

x: Resin fine particles were observed to be localized or to unevenly fix.

<Average Particle Size>

Each of the dispersible colorants was subjected to measurement based on dynamic light scattering by means of an ELS-8000 manufactured by Otsuka Electronics Co., Ltd., and a cumulant average value was defined as an average particle size.

<Surface Functional Group Density>

The surface functional group density of each of the dispersible colorants was determined as follows. A large excessive amount of hydrochloric acid (HCl) was added to a water dispersion of the colorant, and the whole was centrifuged at 20,000 rpm for 1 hour by means of a centrifugal separator for precipitation. The precipitate was re-dispersed into pure water, a solid fraction was determined, and the precipitate was weighed. A known amount of sodium hydrogen carbonate was added, and the whole was stirred to prepare a dispersion. The dispersion was additionally centrifuged at 80,000 rpm for 2 hours by means of a centrifugal separator for precipitation. The supernatant was weighed, and a neutralization amount was determined from neutralization titration by means of a 0.1N aqueous solution of HCl. The known amount of sodium hydrogen carbonate and a blank value measured for pure water were subtracted from the neutralization amount to calculate the surface functional group density. In the case where a colorant obviously had a cationic group as a polar group, the surface functional group density was determined by means of sodium hydroxide (NaOH) instead of an aqueous solution of HCl and ammonium chloride instead of sodium hydrogen carbonate in the same manner.

TABLE 1

| | Dispersible | Dispersible | Dispersible | Dispersible | Dispersible | Dispersible |
|---|---|---|---|---|---|---|
| | colorant 1 | colorant 2 | colorant 3 | colorant 4 | colorant 5 | colorant 6 |
| Pigment | 1 | 1 | 2 | 1 | 2 | 3 |
| dispersion | | | | | | |
| Monomer used | MMA | MMA | MMA | MMA | MMA | MMA |
| | AA | AA | SSNa | M90G | M90G | AA |
| Fixation of | ∘ | ∘ | ∘ | ∘ | ∘ | ∘ |
| resin pseudo | | | | | | |
| fine particles | | | | | | |
| Interspersion | ∘ | ∘ | ∘ | ∘ | ∘ | ∘ |
| properties of | | | | | | |
| resin pseudo | | | | | | |
| fine particles | | | | | | |
| Average | 126 | 118 | 108 | 115 | 112 | 98 |
| particle size | | | | | | |
| (nm) | | | | | | |
| Surface | 370 | 175 | 460 | 350 | 455 | 800 |
| functional | | | | | | |
| group density | | | | | | |
| (μmol/g) | | | | | | |

[Method of Judging Good Medium and Bad Medium in Water-Soluble Organic Solvents Used]

The following experiment was performed in order to select a pigment in each of the pigment dispersions or a good medium and a bad medium with respect to the pigment and a dispersant. First, the pigment dispersions 1 and 2, and aqueous solutions of the dispersible colorants 1 to 6 each having a solid concentration of 10% were prepared. A dispersion for judging a good medium and a bad medium was prepared by using them at the following compounding ratio.

(Compounding Ratio of Dispersion for Judging Good Medium and Bad Medium)

The pigment dispersions 1 and 2, or aqueous solutions of the dispersible colorants 1 to 6 each having a solid concentration of 10%:50 parts

A water-soluble organic solvent shown in Table 2:50 parts

Next, 10 g of the dispersion for judging a good medium and a bad medium thus prepared were charged into a sample bottle made of glass and equipped a cap. After the bottle had been capped, the dispersion was sufficiently stirred, and the bottle was left standing in an oven at 60° C. for 48 hours. After that, the solution taken out of the oven at 60° C. was provided as a sample for measurement, and the particle size of the water-insoluble colorant in the dispersion was measured with a concentrated particle size analyzer (trade name: FPAR-1000; manufactured by Otsuka Electronics Co., Ltd.). The measured particle size was defined as the stock solution particle size (particle size measured without dilution) of the dispersion for judging a good medium and a bad medium after storage under heat at 60° C. for 48 hours. Meanwhile, a pigment water dispersion having the same solid concentration as that of the dispersion for judging a good medium and a bad medium, that is, a pigment water dispersion for judging and comparing a good medium and a bad medium added with the same amount of water instead of a water-soluble organic solvent was prepared as a reference. The water dispersion was not stored under heat, and the particle size of the water-insoluble colorant in the dispersion was measured with the concentrated particle size analyzer in the same manner as that described above. Then, the stock solution particle size of the resultant dispersion for judgment was compared with the particle size of the water dispersion as a reference. A solvent having the stock solution particle size of the dispersion after storage under heat at 60° C. for 48 hours increased as compared to the stock solution particle size of the water dispersion as a reference was judged to be a bad medium, and a solvent having the stock solution particle size of the dispersion after storage under heat at 60° C. for 48 hours equal to or smaller than that of the water dispersion as a reference was judged to be a good medium.

[Method of Measuring Ka Value for Each Water-Soluble Organic Solvent]

First, in measuring the Ka value of each water-soluble organic solvent, a dye aqueous solution at a dye concentration of 0.5% having the following composition was prepared to facilitate the measurement.

| | | |
|---|---|---|
| Water-soluble dye C.I. Direct Blue 199 | 0.5 | part |
| Pure water | 99.5 | parts |

Next, a 20% aqueous solution of each water-soluble organic solvent to be measured stained with the 0.5% dye aqueous solution was prepared at the following compounding ratio.

| | |
|---|---|
| The 0.5% dye aqueous solution | 80 parts |
| A water-soluble organic solvent shown in Table 1 | 20 parts |

The Ka value of the 20% aqueous solution of each water-soluble organic solvent thus prepared was measured by means of a dynamic penetrability testing device S (trade name) manufactured by Toyo Seiki Seisaku-Sho, Ltd. according to a Bristow method.

Table 2 shows the results of judgment as to whether each water-soluble organic solvent that can be used for ink thus measured is a good medium or a bad medium with respect to any one of the pigment dispersions 1 to 3 and the dispersible colorants 1 to 6, and the measurement of the Ka value of each water-soluble organic solvent in a 20% aqueous solution. The term “polyethylene glycol derivative” in Table 2 refers to a derivative having the structure shown below and a molecular weight of about 1,000.

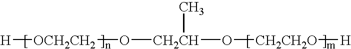

(In the formula, n and m each independently represent a number of 5 to 20.)

TABLE 2

| Water-soluble | | Pigment | Pigment | Pigment |
|---|---|---|---|---|
| organic solvent | Ka value | dispersion 1 | dispersion 2 | dispersion 3 |
| Glycerin | 0.13 | ∘ | ∘ | ∘ |
| Ethylene glycol | 0.09 | ∘ | ∘ | ∘ |
| Trimethylolpropane | 0.19 | ∘ | ∘ | ∘ |
| Polyethylene glycol | 0.17 | x | x | x |
| 600 | | | | |
| Polyethylene glycol | 0.18 | x | x | x |
| derivative | | | | |

| Water-soluble | Dispersible | Dispersible | Dispersible | Dispersible | Dispersible | Dispersible |
|---|---|---|---|---|---|---|
| organic solvent | colorant 1 | colorant 2 | colorant 3 | colorant 4 | colorant 5 | colorant 6 |
| Glycerin | ∘ | ∘ | ∘ | ∘ | ∘ | ∘ |
| Ethylene glycol | ∘ | ∘ | ∘ | ∘ | ∘ | ∘ |
| Trimethylolpropane | ∘ | ∘ | ∘ | ∘ | ∘ | ∘ |
| Polyethylene glycol | x | x | x | x | x | x |
| 600 | | | | | | |
| Polyethylene glycol | x | x | x | x | x | x |
| derivative | | | | | | |

In the table, ∘ represents a good medium and x represents a bad medium

### Examples 1 to 6

Each of the water-soluble organic solvents examined above and one of the dispersible colorants 1 to 6 were mixed with a component shown in Table 3, and the mixture was sufficiently stirred for dissolution or dispersion. After that, the resultant was filtered through a microfilter having a pore size of 3.0 μm (manufactured by Fuji Photo Film Co., Ltd.) under pressure to prepare an ink of each of Examples 1 to 6. At this time, each ink was prepared in such a manner that, when a total amount of a good medium in the ink (mass %) was denoted by A and a total amount of a bad medium in the ink (mass %) was denoted by B, A:B would be in the range of 10:5 to 10:30, and a water-soluble organic solvent showing the maximum Ka value out of respective Ka values of multiple water-soluble organic solvents each determined by a Bristow method as compared to the Ka value of a 20% aqueous solution of the good medium determined by the Bristow method with respect to the water-insoluble colorant would be the bad medium.

TABLE 3

| | | | Example 1 | Example 2 | Example 3 | Example 4 | Example 5 | Example 6 |
|---|---|---|---|---|---|---|---|---|
| Water-insoluble | | Dispersible | 4 | | | | | |
| colorant | | colorant 1 | | | | | | |
| | | Dispersible | | 4 | | | | |
| | | colorant 2 | | | | | | |
| | | Dispersible | | | 4 | | | |
| | | colorant 3 | | | | | | |
| | | Dispersible | | | | 4 | | |
| | | colorant 4 | | | | | | |
| | | Dispersible | | | | | 4 | |
| | | colorant 5 | | | | | | |
| | | Dispersible | | | | | | 4 |
| | | colorant 6 | | | | | | |
| Water- | Good | Glycerin | 5 | 5 | 5 | 7 | 5 | 5 |
| soluble | medium | Ethylene glycol | 5 | | 4 | 4 | | 5 |
| organic | | Diethylene glycol | | | | | | |
| solvent | | Trimethylolpropane | | | | | | |
| | Bad | Polyethylene glycol | 10 | 15 | 10 | | | 8 |
| | medium | 600 | | | | | | |
| | | Polyethylene glycol | | | | 12 | 8 | |
| | | derivative | | | | | | |

| | | | | | | | |
|---|---|---|---|---|---|---|---|
| Surfactant | Acetylenol E-100 | 0.05 | 0.05 | 0.05 | 0.05 | 0.05 | 0.05 |

| | | | | | | |
|---|---|---|---|---|---|---|
| Ion-exchanged water | Remained | Remained | Remained | Remained | Remained | Remained |

In the table, the amount of ion-exchanged water is such that the total amount of ink is 100 parts. The same holds true for any subsequent ink.

### Comparative Examples 1 to 5

(Preparation of Ink)

Each of the water-soluble organic solvents examined above and one of the dispersible colorants 1 and 4 to 6 were mixed with a component shown in Table 4, and the mixture was sufficiently stirred for dissolution or dispersion. After that, the resultant was filtered through a microfilter having a pore size of 3.0 μm (manufactured by Fuji Photo Film Co., Ltd.) under pressure to prepare an ink of each of Comparative Examples 1 to 5.

TABLE 4

| | | | Comparative | Comparative | Comparative | Comparative | Comparative |
|---|---|---|---|---|---|---|---|
| | | | Example 1 | Example 2 | Example 3 | Example 4 | Example 5 |
| Water-insoluble | | Dispersible | 4 | | | | |
| colorant | | colorant 1 | | | | | |
| | | Dispersible | | 4 | | | |
| | | colorant 4 | | | | | |
| | | Dispersible | | | 4 | 4 | |
| | | colorant 5 | | | | | |
| | | Dispersible | | | | | 4 |
| | | colorant 6 | | | | | |
| Water- | Good | Glycerin | 7 | | 7 | 4 | 4 |
| soluble | medium | Ethylene glycol | 5 | | 7 | | |
| organic | | Diethylene glycol | 7 | | | | |
| solvent | | Trimethylolpropane | | | | | |
| | Bad | Polyethylene glycol | | | | 16 | 16 |
| | medium | 600 | | | | | |
| | | Polyethylene glycol | | 15 | 4 | 4 | 4 |
| | | derivative | | | | | |

| | | | | | | |
|---|---|---|---|---|---|---|
| Surfactant | Acetylenol E-100 | 0.05 | 0.05 | 0.05 | 0.05 | 0.05 |

| | | | | | |
|---|---|---|---|---|---|
| Ion-exchanged water | Remained | Remained | Remained | Remained | Remained |

(Evaluation)

Each of the inks of Examples 1 to 6 and Comparative Examples 1 to 5 was evaluated for the following items by means of an ink jet recording apparatus BJS-700 (manufactured by CANON Inc.) having an on-demand multi-recording head for ejecting ink by applying thermal energy to the ink in accordance with a recording signal. Table 5 shows the results of evaluation for Examples and Table 6 shows the results of evaluation for Comparative Examples.

1. Average Printing Density

Each of the above inks and the ink jet recording apparatus were used to print a letter including a solid portion measuring 2 cm×2 cm on each of plain papers A to C for copying. One day after the printing, the printing density of the solid portion measuring 2 cm×2 cm was measured with an RD918 manufactured by Macbeth. A printer driver was in a default mode. Setting conditions for the default mode were shown below. The eject amount per dot of ink was in the range of 30 ng±10%.

Kind of paper: Plain paper

Printing quality: Standard

Color adjustment: Automatic

Each ink was evaluated by means of the printing density obtained as a result of such measurement as described above according to the following criteria.

∘: The average of the printing densities on the three papers was 1.5 or more.

x: The average of the printing densities on the three papers was less than 1.5.

The following papers were used as the plain papers.

A: PPC paper NSK manufactured by CANON Inc.

B: PPC paper 4024 manufactured by Fuji Xerox Co., Ltd.

C: PPC paper Prober Bond manufactured by Fox River

2. Penetrable Plain Paper Printing Density

The printing density on the paper B out of the above results was evaluated according to the following criteria.

∘: The printing density on the paper B was 1.4 or more.

x: The printing density on the paper B was less than 1.4.

3. Storage Stability

Each of the inks of Examples 1 to 6 and Comparative Examples 1 to 5 was charged into a shot bottle, and the bottle was tightly stopped. Then, the bottle was placed in an oven at 60° C. 2 months after that, the bottle was taken out, and the storage stability was evaluated from the state of the ink at that time according to the following criteria.

∘: A colorant in ink is stably and evenly dispersed.

Δ: No or small change in appearance occurs, but a viscosity or an average particle size slightly increases.

x: Ink is turned into gel, or an upper portion of the ink is transparent. Alternatively, the viscosity of the ink obviously increases.

4. Letter Quality

A 16-point letter portion of the printing sample was visually observed, and the bleeding of a letter was evaluated according to the following criteria.

A: Nearly no bleeding occurs.

B: Some letters are observed to bleed.

C: A large number of letters bleed.

5. Abrasion Resistance

The sample was left standing for 24 hours after the printing. Silbon paper was mounted on the printed paper, and the Silbon paper was pulled in a state where a spindle having a load of 40 g/cm² was mounted on a recording surface. At that time, whether each of a no-printing portion (white portion) of the recording paper and the Silbon paper was contaminated by the abrasion with the printing portion was visually observed and the abrasion resistance was evaluated according to the following criteria.

A: No portion contaminated by abrasion is observed.

B: Nearly no portion contaminated by abrasion is observed.

C: A portion contaminated by abrasion is remarkable.

6. Marker Resistance

A 14-point letter portion of the printing sample was traced with a fluorescent yellow marker pen (Zebra Optics) once, and the disturbance of the printing portion was visually observed and evaluated according to the following criteria.

A: No disturbance of printing is present in the traced portion.

B: Slight disturbance of printing is present in the traced portion, and the tip of the pen is contaminated little.

C: Disturbance of printing in the traced portion is remarkable, and the tip of the pen is stained.

7. Water Resistance

The printing surface of the printing sample was tilted by an angle of 45° relative to a horizontal surface, and 1 ml of water was dropped on a 14-point letter portion by means of a dropper from a height of 20 cm. At this time, the degree of bleeding of printing was evaluated according to the following criteria.

A: Nearly no bleeding of printing is observed.

B: Slight bleeding of printing is observed, but nearly no trace is present in a white paper portion.

C: A color bleeds from the printing portion, and a trace is observed in a white paper portion.

TABLE 5

| | Exam- | Exam- | Exam- | Exam- | Exam- | |
|---|---|---|---|---|---|---|
| | ple 1 | ple 2 | ple 3 | ple 4 | ple 5 | Example 6 |
| Average | ∘ | ∘ | ∘ | ∘ | ∘ | ∘ |
| printing | | | | | | |
| density | | | | | | |
| Penetrable | ∘ | ∘ | ∘ | ∘ | ∘ | ∘ |
| plain paper | | | | | | |
| printing | | | | | | |
| density | | | | | | |
| Storage | A | A | A | A | A | A |
| stability | | | | | | |
| Letter | A | A | A | A | A | A |
| quality | | | | | | |
| Abrasion | A | A | A | A | A | A |
| resistance | | | | | | |
| Marker | A | A | A | A | A | A |
| resistance | | | | | | |
| Water | A | A | A | A | A | A |
| resistance | | | | | | |

TABLE 6

| | Com- | Com- | Com- | Com- | |
|---|---|---|---|---|---|
| | parative | parative | parative | parative | Comparative |
| | Example 1 | Example 2 | Example 3 | Example 4 | Example 5 |
| Average | x | ∘ | x | ∘ | ∘ |
| printing | | | | | |
| density | | | | | |
| Penetrable | x | ∘ | x | ∘ | ∘ |
| plain | | | | | |
| paper | | | | | |
| printing | | | | | |
| density | | | | | |
| Storage | ∘ | x | ∘ | Δ | Δ |
| stability | | | | | |
| Letter | B | A | B | B | B |
| quality | | | | | |
| Abrasion | A | A | A | A | A |
| resistance | | | | | |
| Marker | A | A | A | A | A |
| resistance | | | | | |
| Water | A | A | A | A | A |
| resistance | | | | | |

### Examples 7 to 12

The inks of Examples 1 to 6 as black inks as described above were used in combination with color inks to form images. The color inks used at this time (three colors, that is, cyan, magenta, and yellow) were prepared as follows.

(Preparation of Cyan Ink)

The following components were mixed, and the mixture was sufficiently stirred for dissolution or dispersion. After that, the resultant was filtered through a microfilter having a pore size of 0.2 μm (manufactured by Fuji Photo Film Co., Ltd.) under pressure to prepare a cyan ink.

| | | |
|---|---|---|
| Direct Blue (DBL) 199 | 3.5 | parts |
| Glycerin | 7.5 | parts |
| Diethylene glycol | 7.5 | parts |
| Acetylenol E-100 | 1.0 | part |
| Pure water | 80.5 | parts |

(Preparation of Magenta Ink)

A magenta ink was prepared by means of the following components in the same manner as in the cyan ink.

| | | |
|---|---|---|
| Acid Red (AR) 289 | 2.5 | parts |
| Glycerin | 7.5 | parts |
| Diethylene glycol | 7.5 | parts |
| Acetylenol E-100 | 1.0 | part |
| Pure water | 81.5 | parts |

(Preparation of Yellow Ink)

A yellow ink was prepared by means of the following components in the same manner as that described above.

| | | |
|---|---|---|
| Direct Yellow (DY) 86 | 2.5 | parts |
| Glycerin | 7.5 | parts |
| Diethylene glycol | 7.5 | parts |
| Acetylenol E-100 | 1.0 | part |
| Pure water | 81.5 | parts |

(Evaluation)

The respective black inks of Examples 1 to 6 and the color inks thus prepared were used in combination, and were evaluated for the following items by means of the above-described ink jet recording apparatus having an on-demand multi-recording head for ejecting ink by applying thermal energy to the ink in accordance with a recording signal shown in FIG. 12. Table 7 shows the results of evaluation.

8. Eject Stability

The eject stability was evaluated as follows according to the following criteria. A specific Bk text was continuously printed on 200 sheets, and the initial printed matter and the final printed matter were visually compared with each other and evaluated according to the following criteria.

A: No stripe, unevenness, or the like occurs, and there is no difference between the initial printed matter and the final printed matter.

B: Slight stripe, unevenness, and misdirection are observed, but printing can be performed without any problem.

C: A significant reduction in quality is observed, or printing cannot be performed.

9. Bleed Resistance

Solid portions of black and respective colors (yellow, magenta, and cyan) were printed on the paper A to be evaluated so as to be adjacent to each other. Then, the degree of bleeding at a boundary between black and each of the colors was visually observed and evaluated according to the following criteria.

AA: No bleeding is observed.

A: Nearly no bleeding is remarkable.

B: Slight bleeding is observed.

C: Bleeding occurs to such an extent that a boundary between colors is unclear.

10. Quick Drying Property

The paper A to be evaluated was subjected to printing by means of the ink jet recording apparatus used in each of Examples 1 to 6. 5 seconds after the printing, Silbon paper was mounted on the printed paper, and the Silbon paper was pulled in a state where a spindle having a load of 40 g/cm² was mounted on a recording surface. At that time, whether each of a no-printing portion (white portion) of the recording paper and the Silbon paper was contaminated by the abrasion with the printing portion was visually observed for the sample and the quick drying property was evaluated according to the following criteria.

A: No portion contaminated by abrasion is observed.

B: Nearly no portion contaminated by abrasion is observed.

C: A portion contaminated by abrasion is remarkable.

TABLE 7

| | Exam- | Exam- | Exam- | Exam- | Exam- | Example |
|---|---|---|---|---|---|---|
| | ple 7 | ple 8 | ple 9 | ple 10 | ple 11 | 12 |
| Black ink | Exam- | Exam- | Exam- | Exam- | Example 5 | Example 6 |
| | ple 1 | ple 2 | ple 3 | ple 4 | | |
| Eject | A | B | A | A | A | A |
| stability | | | | | | |
| Bleed | A | A | AA | A | AA | AA |
| resistance | | | | | | |
| Quick | B | B | A | B | A | A |
| drying | | | | | | |
| property | | | | | | |

According to the present invention, there is provided an aqueous ink which has excellent long-term storage stability and eject stability, and is capable of providing a high printing density irrespective of the penetration performance of a recording medium and of providing a printed matter with excellent abrasion resistance, marker resistance, and water resistance. According to the present invention, there are also provided an aqueous ink capable of providing a high printing density at all times while having excellent long-term storage stability and eject stability, and an aqueous ink which has excellent printing quality and has bleed resistance against any other ink. According to the present invention, there is also provided an aqueous ink which maintains a high printing density at all times and has excellent quick drying property. According to the present invention, there is also provided an ink jet recording method involving the use of such ink to provide good printing performance even in a plain paper medium having high penetrability. As another effect of the present invention, there are provided an ink tank, an ink jet recording apparatus, and an ink jet recorded image each of which can be suitably used for the recording method.

The application claims the priority from Japanese Patent Application No. 2004-186930 filed on Jun. 24, 2004, which is hereby incorporated by reference herein.

What is claimed is:

1. An aqueous ink comprising: water; multiple water-soluble organic solvents; and a dispersible colorant, the aqueous ink containing a good medium with respect to the dispersible colorant and a bad medium with respect to the dispersible colorant as the water-soluble organic solvents, wherein:
the dispersible colorant comprises a colorant and chargeable resin pseudo fine particles smaller than the colorant, the colorant and the chargeable resin pseudo fine particles fix to each other; and
when a total amount of the good medium in the ink (mass %) is denoted by A and a total amount of the bad medium in the ink (mass %) is denoted by B, A:B is in a range of 10:5 to 10:30, and a water-soluble organic solvent showing a maximum Ka value out of respective Ka values of the multiple water-soluble organic solvents each determined by a Bristow method comprises the bad medium.

2. An aqueous ink according to claim 1, wherein the dispersible colorant has a surface functional group density of 250 μmol/g or more and less than 1,000 μmol/g.

3. An aqueous ink according to claim 1, wherein the colorant composing the dispersible colorant has a hydrophilic group on a surface of the colorant.

4. An aqueous ink according to claim 3, wherein the hydrophilic group is bonded to the surface of the colorant directly and via another atomic group.

5. An aqueous ink according to claim 1, wherein the colorant shows a heating loss in a range of 2% to 20%.

6. An aqueous ink according to claim 1, wherein the chargeable resin pseudo fine particles contain at least a polymer obtained by polymerizing at least a monomer represented by the following formula (1):
CH₂═C(R¹) COO(R²O)ₙR³ (1)
wherein R¹ represents a hydrogen atom or an alkyl group having 1 to 5 carbon atoms, R² represents a divalent hydrocarbon group having 1 to 30 carbon atoms which may have a hetero atom, R³ represents a hydrogen atom or a monovalent hydrocarbon group having 1 to 30 carbon atoms which may have a hetero atom, and n represents a number of 1 to 60.

7. An ink tank comprising the aqueous ink according to claim 1.

8. An ink jet recording apparatus comprising the aqueous ink according to claim 1 mounted on the ink jet recording apparatus.

9. An ink jet recording method comprising forming an image by an ink jet recording apparatus by means of the aqueous ink according to claim 1.

10. An ink jet recorded image formed by an ink jet recording apparatus by means of the aqueous ink according to claim 1.
